(19) United States
(12) Patent Application Publication
(10) Pub. No.: US 2005/0240393 A1
(43) Pub. Date: Oct. 27, 2005

(54) Method, system, and software for embedding metadata objects concomitantly wit linguistic content

(76) Inventor: John Francis Glosson, El Sobrante, CA (US)

Correspondence Address: CHARLES LOUIS THOEMING, 1390 WILLOW PASS ROAD, SUITE 1020, CONCORD, CA, 94520, US

(21) Appl. No.: 11/114,553

(22) Filed: Apr. 25, 2005

Related U.S. Application Data
(63) Continuation of application No. 60/565,496, filed on Apr. 26, 2004.

(51) Int. Cl. G06F 17/20

(52) U.S. Cl. 704/8

(57) ABSTRACT

The present invention represents a server based system, a server based method and computer software to embed metadata objects concomitantly with linguistic content over any editor supporting cut and paste operations, without change to the editor. An embodiment of the invention to manage terminology and facilitate efficient internationalization and localization of linguistic content in a document set is disclosed.

### CROSS-REFERENCES TO RELATED APPLICATIONS

This United States non-provisional patent application is based upon and claim the filing date of U.S. provisional patent application Ser. No. 60/565,496, filed 26 Apr. 2004.

### STATEMENT REGARDING FEDERALLY SPONSORED RESEARCH OR DEVELOPMENT

None.

### REFERENCE TO A MICRO-FICHE APPENDIX

None.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the file or records as maintained by the United States Patent and Trademark Office, but otherwise reserves all copyright rights whatsoever.

### BACKGROUND OF THE INVENTION

1. Field of the Invention

The present invention relates to a replacement algorithm for porting linguistic content within one language into another language using concomitant Unicode characters in a specific replacement scheme to differentiate semantic meaning.

2. Description of the Related Art

A preliminary search of the art located the following patent or patent publications which are believed to be representative of the present state of the prior art: U.S. Pat. No. 5,890,176, issued Mar. 30, 1999; U.S. Pat. No. 6,092,037, issued Jul. 18, 2000; U.S. Pat. No. 6,275,790, issued Aug. 14, 2001; U.S. Pat. No. 6,311,151, issued Oct. 31, 2001; U.S. Pat. No. 6,349,275, issued Feb. 19, 2002; U.S. Pat. No. 6,453,462, issued Sep. 17, 2002; U.S. Pat. No. 6,507,812, issued Jan. 14, 2003; U.S. Patent Publication No. 2004/0189682, published Sep. 30, 2004; and U.S. Patent Publication No. 2004/0199490, published Oct. 7, 2004.

### BRIEF SUMMARY OF THE INVENTION

In Western Europe and America the physical character by character switch from 1252 codepage to similar looking, but not identical characters for the purposes of adding robustness to internationalization testing of software applications is considered best practice in the art. The objective of character replacement is to ensure that software applications are tested using multi-byte character data instead of single byte character data. Many foreign languages, particularly those from the Far East, such as Japanese, Korean, and Chinese, are expressed using multi-byte character sets. Accordingly, testing of user interface and business logic functioning with multi-byte data instead of authored single byte is considered essential prior to global release. Choice of character substitution historically has not been governed by any algorithm, instead the replacement characters are chosen for their visual similarity to the single-byte language in which the software is authored. This technique is known as mock or pseudo translation in the art.

The present invention modifies the algorithm governing character substitution and controls character rendering to the end-user via custom font. The character replacement algorithm of the present invention is designed to: 1) provide visual similarity to a 1252 authored language so that mock versions can be navigated as if the versions were 1252 authored language; 2) provide enough visual dissimilarity from an authored language to permit the author to readily distinguish areas within a text file that have been marked for translation from those not so marked; 3) define and then store sense metadata precisely within the authored document; 4) concomitantly embed Unicode characters as metadata objects for a variable length text string within any editor supporting cut and paste operations; 5) significantly simplify translation from and into any language represented by Unicode characters; 6) operate from a Web-based service platform without the necessity of a proprietary text editor; 7) hide the Unicode metadata object from the end-user by controlling font mapping; and 8) improve machine translation accuracy by furnishing means to eliminate sense ambiguity from source and unambiguously tie text within source to terminological definitions and translations within a centralized terminological database.

It is, therefore, an object of the present invention to provide a server based system, a server based method and computer software to embed metadata objects concomitantly with linguistic content over any editor supporting cut and paste operations, without change to the editor.

It is, therefore, a further object of the present invention to provide a methodology whereby explicit definition of relevant localization and internationalization detail can be embedded within originally authored documents, including a variable length text string within any editor supporting cut and past operations.

It is another object of the present invention to simplify the process by which primary language applications are ported to foreign languages.

It is yet another object of the present invention to provide an independent business process outsourcing model to the software industry for software engineering in which primary language applications are ported to foreign languages.

It is still yet another object of the present invention to provide an improved communications tool to serve dispersed authoring groups, across multiple time zones and countries, attempting to collaborate on a single product, including operations from a Web-based service platform without the necessity of a proprietary text editor.

A further object of the present invention is to provide visual similarity to a 1252 authored language so that mock versions can be navigated as if the versions were in a 1252 authored language rendered to the user interface using commercially available fonts.

Yet another object of the present invention is to provide enough visual dissimilarity from the original authored language to permit the author to readily distinguish areas within a text file that have been marked for translation from those not so marked.

Still yet another object of the present invention is to define and then store sense metadata precisely within the authored document.

Other features, advantages, and objects of the present invention will become apparent with reference to the following description and accompanying drawings.

### BRIEF DESCRIPTION OF THE DRAWINGS

FIG. 1 is a flow chart illustrating steps in a process for user login 100 for an embodiment of the present invention employing web based or other micro-processor based user login functions.

FIG. 2 is a flow chart illustrating steps in a process for user main sense flow 200 for an embodiment of the present invention employing web based or other micro-processor based user login functions.

FIG. 3 is a flow chart illustrating an algorithm for user text input 300 for an embodiment of the present invention employing web based or other micro-processor based user login functions.

FIG. 4 is a flow chart illustrating an algorithm for Unicode token tag structure for user text input 400 for an embodiment of the present invention employing web based or other micro-processor based user login functions.

FIG. 5 is a flow chart illustrating an algorithm for dictionary and custom sense data store lookup for user text input 500 for an embodiment of the present invention employing web based or other micro-processor based user login functions.

FIG. 6 is a flow chart illustrating an algorithm for delivering Unicode metadata objects for user text input 600 for an embodiment of the present invention employing web based or other micro-processor based user login functions.

FIG. 7 is a flow chart illustrating an algorithm for character replacement to generate Unicode metadata objects for user text input 700 for an embodiment of the present invention employing web based or other micro-processor based user login functions.

FIG. 8 is a flow chart illustrating an algorithm for associating Unicode metadata objects with internationalization instructions within a data storage mechanism for user variable length text input from cut and paste operations 800 for an embodiment of the present invention employing web based or other micro-processor based user login functions.

FIG. 9 is a flow chart illustrating an algorithm for recognizing terminology and forwarding terminology translation pairs to a Machine Translation engine 900 for an embodiment of the present invention employing web based or other micro-processor based user login functions.

FIG. 10 is a flow chart illustrating an algorithm for user selection of semantic meaning for user variable length text input from cut and paste operations 1000 for an embodiment of the present invention employing web based or other micro-processor based user login functions.

FIG. 11 is a flow chart illustrating steps in a process for user invoked translation pair flow 1100 for an embodiment of the present invention employing web based or other micro-processor based user login functions.

FIG. 12 is a flow chart illustrating steps in a process for configuration of the software client 1200 for an embodiment of the present invention employing web based or other micro-processor based user login functions.

FIG. 13 is a schematic of the architecture of the system of an embodiment of the present invention for internationalization and localization of linguistic content depicting principal system components and sub-components.

FIG. 14 is a representative interactive queuing screen of an embodiment of the method and system of the present invention employing web based or other micro-processor based user logon functions.

FIG. 15 is a representative interactive queuing screen of an embodiment of the method and system of the present invention employing web based or other micro-processor based user precise term login module for UI language, document language, target language, and organization selection.

FIG. 16 is a representative interactive queuing screen of an embodiment of the method and system of the present invention employing web based or other micro-processor based precise term login module with user input for product selection.

FIG. 17 is a representative interactive queuing screen of an embodiment of the method and system of the present invention employing web based or other micro-processor based precise term login module with user input option for domain settings.

FIG. 18 is a representative interactive queuing screen of an embodiment of the method and system of the present invention employing web based or other micro-processor based depicting a representative user masked phrase in a client function (FIG. 13) #3090 text masking module.

FIG. 19 is a representative interactive queuing screen of an embodiment of the method and system of the present invention employing web based or other micro-processor based depicting a representative user masked phrase in a client function (FIG. 13) #3100 text masking module.

FIG. 20 is a representative interactive queuing screen of an embodiment of the method and system of the present invention depicting a representative user masked phrase in Microsoft's Notepad wherein the client software receives an XML response, loads the clipboard and pastes content back into the editor.

FIG. 21 is a representative interactive queuing screen of an embodiment of the method and system of the present invention employing web based or other micro-processor leverage module whereby the user invokes client function to embed internationalization instructions within source.

FIG. 22 is a representative interactive queuing screen of an embodiment of the method and system of the present invention employing web based or other micro-processor based internationalization block modules within the translator workbench wherein matched records containing i18n template data are returned by the server to the client.

FIG. 23 is a representative interactive queuing screen of an embodiment of the method and system of the present invention employing web based or other micro-processor based internationalization template and internationalization record mechanism modules wherein template details are leveraged in a new i18n record.

FIG. 24 is a representative interactive queuing screen of an embodiment of the method and system of the present invention employing web based or other micro-processor based comments to internationalization records or templates modules wherein client software receives a text string, loads the clipboard, and pastes content back into the editor.

FIG. 25 is a representative interactive queuing screen of an embodiment of the method and system of the present invention employing web based or other micro-processor based notepad for sense editing module(s) depicting a user selection of a variable length text string within any editor supporting cut and paste functions.

FIG. 26 is a representative interactive queuing screen of an embodiment of the method and system of the present invention employing web based or other micro-processor based depicting a representative automatic recognition of terminology within source wherein client software receives an XML response, loads the clipboard, and pastes content back into the editor.

FIG. 27 is a representative interactive queuing screen of an embodiment of the method and system of the present invention employing web based or other micro-processor based notepad for sense editing module(s) depicting a user selection of a variable length text string within any editor supporting cut and paste functions.

FIG. 28 is a representative interactive queuing screen of an embodiment of the method and system of the present invention whereby the user navigates through the part of speech tabs and searches for an appropriate meaning for input text.

FIG. 29 is a representative interactive queuing screen of an embodiment of the method and system of the present invention employing web based or other micro-processor based depicting a representative edit sense module wherein client software receives an XML response, loads the clipboard, and pastes content back into the editor.

FIG. 30 is a representative interactive queuing screen of an embodiment of the method and system of the present invention wherein responding to a standard sense meaning, the user provides a description of the new sense, domain categorization, and glossary flag within the appropriate part of the speech grid and selects “OK” from the interactive screen.

FIG. 31 is a representative interactive queuing screen of an embodiment of the method and system of the present invention whereby the client server directs the user to “Override tab” and carries over information from the original sense choice and whereby the user can add comments to distinguish this entry from a standard sense.

FIG. 32 is a representative interactive queuing screen of an embodiment of the method and system of the present invention employing web based or other micro-processor based depicting a representative override module wherein client software receives an XML response, loads the clipboard, and pastes content back into the editor.

FIG. 33 is a representative interactive queuing screen of an embodiment of the method and system of the present invention depicting a server returned SOAP XML message containing translation pairs and the client displays the same.

FIG. 34 is a representative queuing screen of an embodiment of the method and system of the present invention permitting configuration of interactive client web service address and port setting.

FIG. 35 is a representative queuing screen of an embodiment of the method and system of the present invention permitting assignment of interactive accelerator key stroke to web server command map.

FIG. 36 is a representative queuing screen of an embodiment of the method and system of the present invention permitting selection of alternative text expressing like or similar nuance.

FIG. 37 is a representative queuing screen of an embodiment of the method and system of the present invention depicting how sense and context are relayed to translators within an environment where human translation work is done.

### DETAILED DESCRIPTION OF THE INVENTION

The present invention comprises a method for embedding metadata objects concomitantly with linguistic content stored on a data storage medium and accessible by a computer processor. A first step in this method is transmitting a user-defined, variable length text string within a client based product and function that supports cut and paste operations within its editor to the processor.

Next, the method includes parsing linguistic tokens within the text string into an array of in-memory tag elements.

After the parsing step, the method includes deriving a metadata object for each in-memory tag element composed exclusively of Unicode codepoints which links to a record in a data storage medium.

The derived metadata objects are then concatenated into a plurality of meta-data objects, and the plurality of metadata objects are then returned to the client based product and function.

The method controls the user interface appearance of the plurality of metadata objects within the client based product using custom font; however, the client based product and function is not changed or controlled by the method.

The method of the present invention further comprises the steps of: (1) constructing document versions from the plurality of metadata objects; and refining document versions including enhancing the plurality of metadata objects and their associated records within the data storage medium.

The present invention comprises a system for embedding metadata objects concomitantly with linguistic content stored on a data storage medium and accessible by a computer processor. The system comprises a data input device initiating a user-defined, variable length text string session within a client based product and function module that supports cut and paste operations within its editor to the processor.

The system further includes a tag structure module to parse linguistic tokens within the text string into an array of in-memory tag elements and a Unicode key module to derive a metadata object exclusively of Unicode codepoints that links to a record in the data storage medium.

The system of the present invention provides a plurality of metadata objects module for concatenated derived metadata objects, whereby the client based product and function module is not changed or controlled by the system and the appearance of the plurality of metadata objects within the client based product and function module is controlled by custom font.

The system of the present invention further comprises a module to construct document versions from the plurality of metadata objects and a module to refine document versions and to enhance the plurality of metadata objects and their associated records within the data storage medium.

The present invention includes a computer-program product for use in a system having at least one data communications network, at least one content server connected to the data communications network, a data storage medium, at least one computer processor, and at least one end user electronic display device connected to the data communications network, wherein the network is a distributed hypermedia environment, the computer program comprising a computer usable medium having computer readable program code physically embedded therein. The computer program code further comprises computer readable program code to initiate a user-defined, variable length text string within a client based product and function to the processor.

The computer program code further comprises computer readable program code to parse linguistic tokens within the text string into an array of in-memory tag elements.

The computer program code further comprises computer readable program code to derive a metadata object composed exclusively of Unicode codepoints linked to a record in a data storage medium.

The computer program code further comprises computer readable program code to concatenate derived metadata objects into a plurality of metadata objects and computer readable program code to return the plurality of metadata objects to the client based product and function.

The client based product and function module is not changed or controlled by the computer readable program code and the appearance of the plurality of metadata objects within the client based product and function module is controlled by custom font.

The computer program product of the present invention further comprises computer readable program code to construct document versions from the plurality of metadata objects. The computer program product of the present invention further comprises computer readable program code to refine document versions and enhance the plurality of metadata objects and their associated records within the data storage medium.

The methods and system of a preferred mode of the present invention enables content developers to embed pseudo language text directly into primary language files in contrast to the industry practice of generating pseudo language interfaces after completing the primary language file. Pseudo content is created by the present invention through an engineering process that employs knowledge of the metadata object language to extract primary language text blocks believed to be exposed on the user interface and, thus, in need of translation. In the art, there is uncertainty that the extraction and reinsertion process is 100 percent reliable. Further, there is considerable time and staffing expense inherent in creating a distinct pseudo language. A separate build process is necessary to produce the software product for the quality assurance test team. By embedding pseudo content within the primary language file and with the pseudo text readily distinguishable from its single-byte surroundings, the present invention dispenses with the requirement of an intimate knowledge of the primary files' formatting in order to accurately and reliably extract, interpret, and produce foreign language replicas for the primary files.

The methods and system of the present invention divide primary language files into language neutral and language variant sections. This is a critical feature of the present invention in significant cost reduction for internationalizing and localization of software applications. As discussed above, elimination of uncertainty as to which areas of a series of developer created text files should be translated during localization is a feature of the present invention. The converse, that is knowledge that certain areas within a file should not be translated, is an equally important facet to preserve correct application functionality. Often localization engineers introduce a class of errors due to over-translation of content that should be language invariant. These types of translation errors are avoided entirely by developers explicitly specifying where content is language invariant from that where it is localizable.

The methods and system of the present invention permit a developer to know for certain during unit testing if their user interface components will be covered in a transition to a new language. This certainty is provided by visual dissimilarity within the authored text file and in a development environment that exposes the text file as visual design components in, for example, Microsoft7's Visual Studio.NET with Form.vb or Form.cs files.

Confirmation of a product's user interface is known as localizability. Localizability validation rests on the strength of the techniques used by the engineers of the mock or pseudo language. As discussed herein, the completeness of mock translation depends on the extraction and reinsertion algorithms, which are sometimes inaccurate or incomplete. The methods and system of the present invention dispense with need for an extraction or reinsertion step since the pseudo content resides within the workflow text files. These workflow text files are ready to be built unmodified into a software product that can be tested for full localizability. As an added feature and benefit, the clear signature of the replacement characters in the midst of the language invariant original characters provided by the methods and system of the present invention permits ease of extraction and reinsertion when foreign language files that correspond to the primary language analogies are needed.

The methods and system of the present invention provide embedding explicit instructions on content and syntax meaning within the authored document. In this manner, the author can communicate their intentions to enablers, such as translators, further downstream in the localization process chain. Most software applications mandate terse wording to maximize screen real estate. Terseness begets ambiguity. Thus, for the translator, knowledge of author intent is critical to accurate text interpretation. With knowledge of author intent, translators need not query clients on meaning and are less apt to make linguistic mistakes due to inappropriate interpretation. Preventing a potential linguistic error at its source is in line with the adage “an ounce of prevention is worth a pound of cure.” Additionally, when large numbers of languages are scheduled to be spawned from this single pivot language, uncertainty in the source has a profoundly negative multiplier effect.

The methods and system of the present invention's content author plug-in (“API”) are designed to be deployed within all major content authoring environments including, but not limited to, eClipse®7, Microsoft®7 Excel®7, Microsoft®7 Word7, Star Office7®, Frontpage7, and the like, which expose an automation API and permit outside interaction with an internal editor view. The plug-in layer requires modification to support the automation model exposed by the host application. Furthermore, the plug-in is deployable to web based WYSIWYG DHTML editors supported by commercial content management systems including, but not limited to, those systems offered by Vignette7™, Interwoven7™, and Documentum7™, and the like. In contrast, the web services, portal and integrated content editor components are designed to be invariant to authoring environment and client engagement.

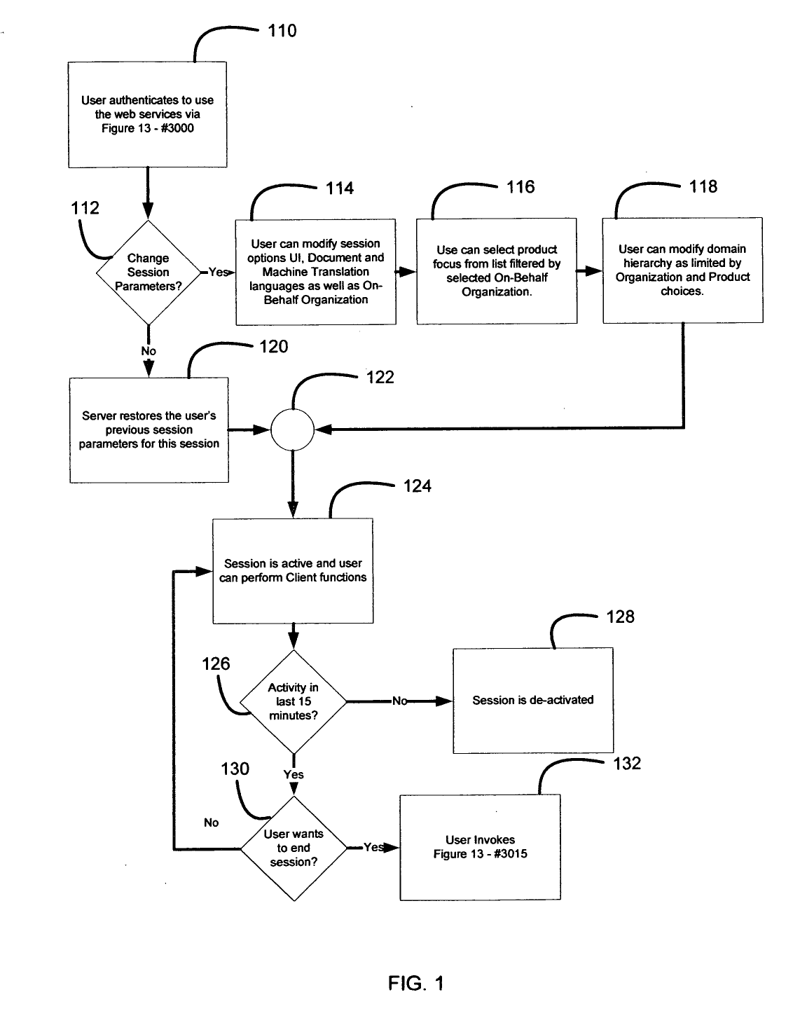

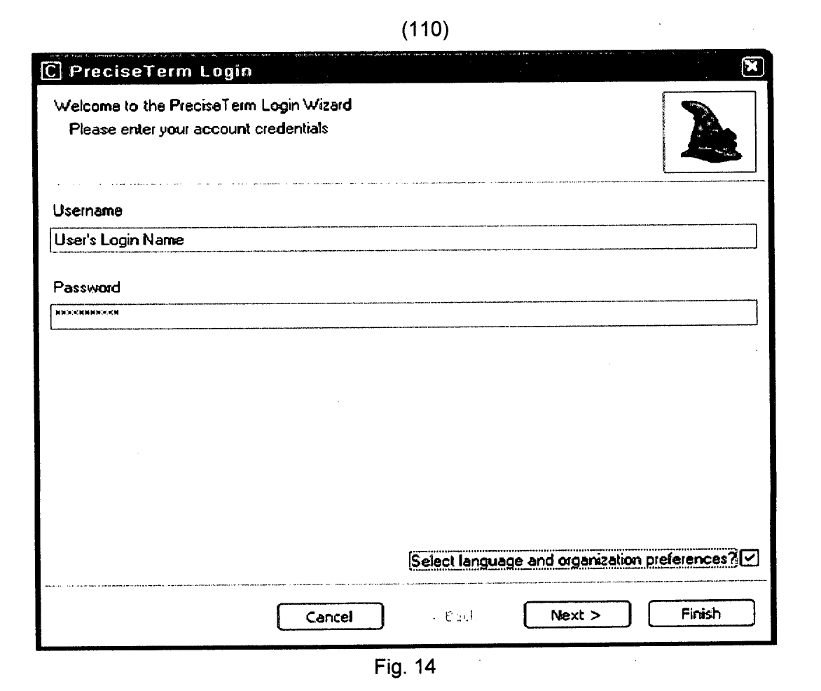

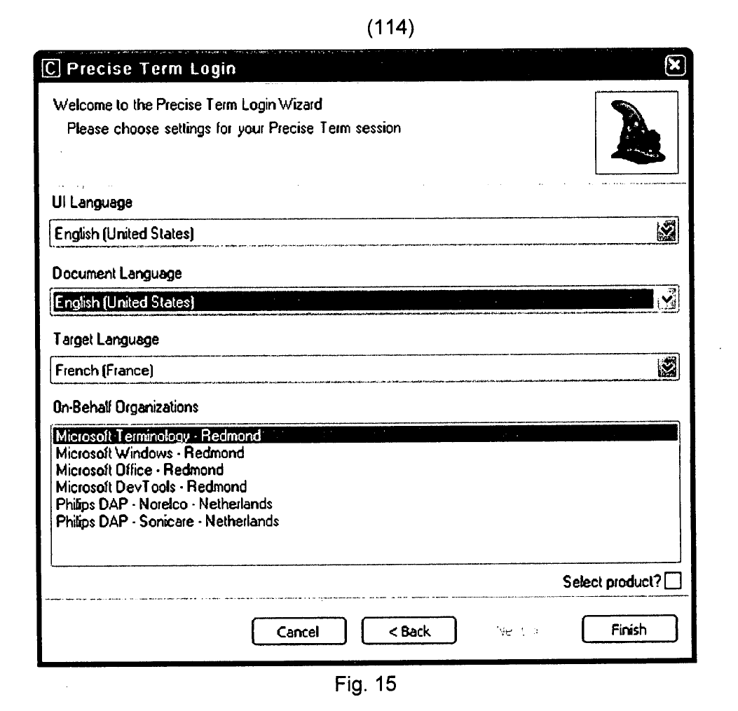

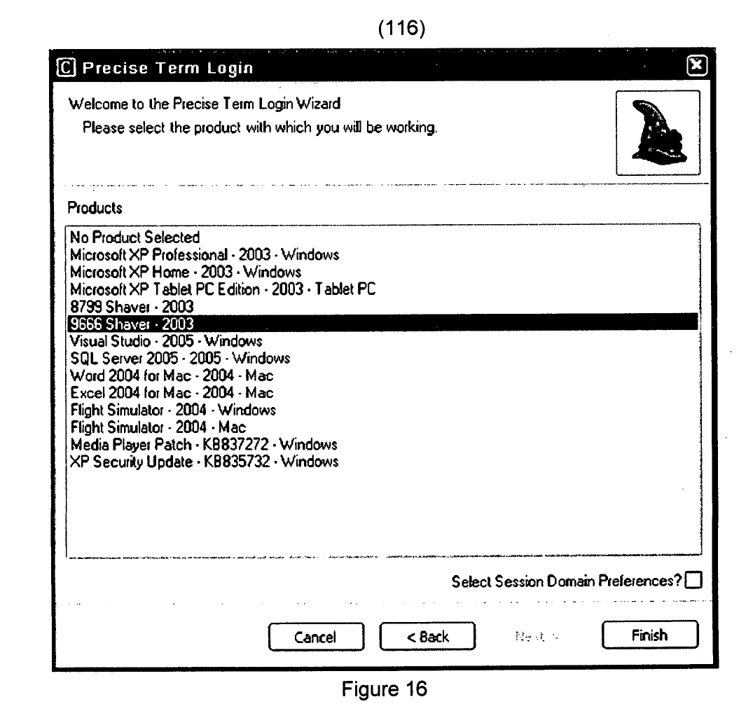

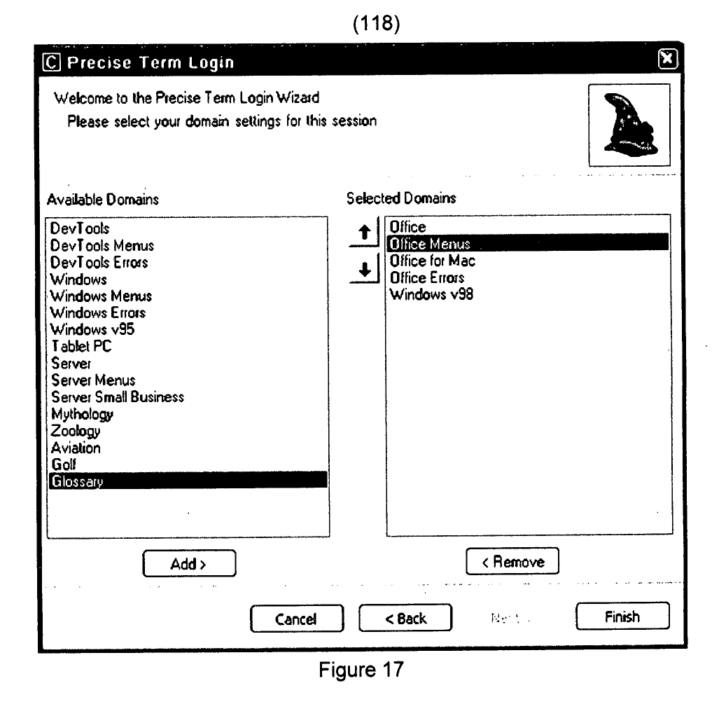

User main login flow 100 is illustrated in FIG. 1. By initializing the client login function 110 the user is authenticated by inputting a previously authorized user name and password (FIG. 14). The authenticated user then indicates whether there is a change is session parameters 112. If session parameters are changed, the user can modify session options, user interface (UI), document and machine translation languages, and on-behalf organization (FIG. 15) 114. The user can further select product focus from lists filtered by selected on-behalf organization (FIG. 16) 116, and then modify domain hierarchy as limited by organization and product choices (FIG. 17) 118. If no session parameters have changes, the server restores the user's previous session parameters for the current session 120. The current session 122 is now active and the user can perform client functions 124. A session timing function 126 determines if there has been any session activity in the last 15 minutes. If not, the session is de-activated 128. At any time, the user can elect to end the session 130 invoking the logout function 132.

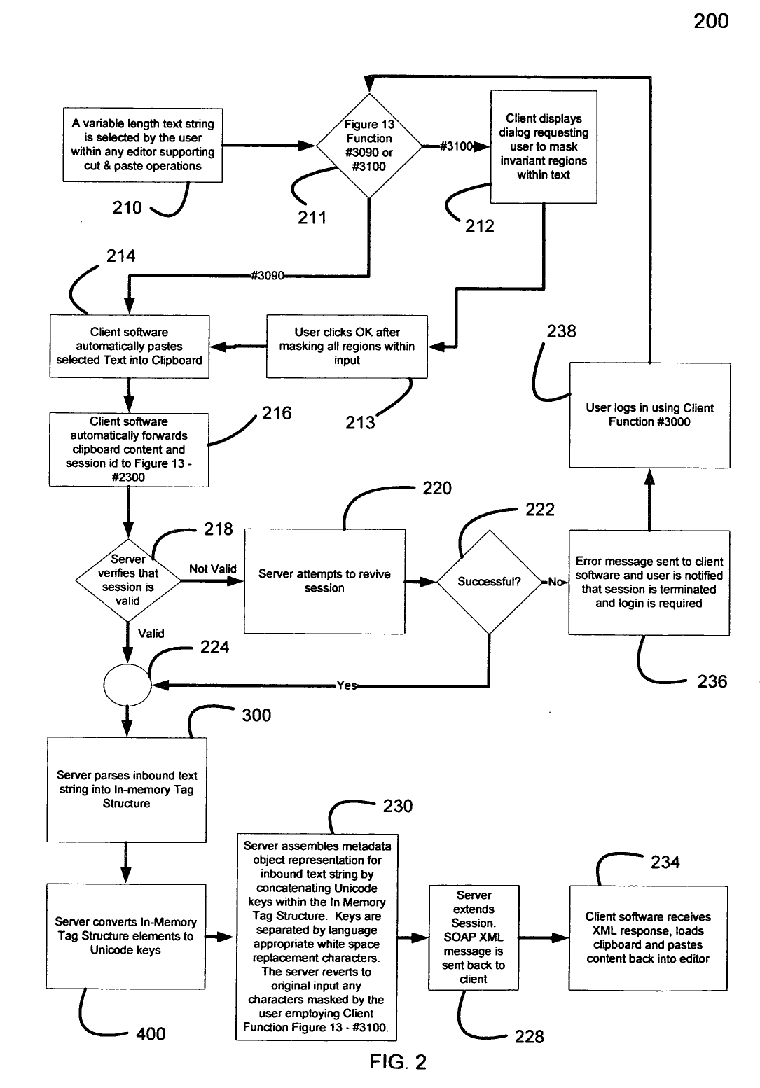

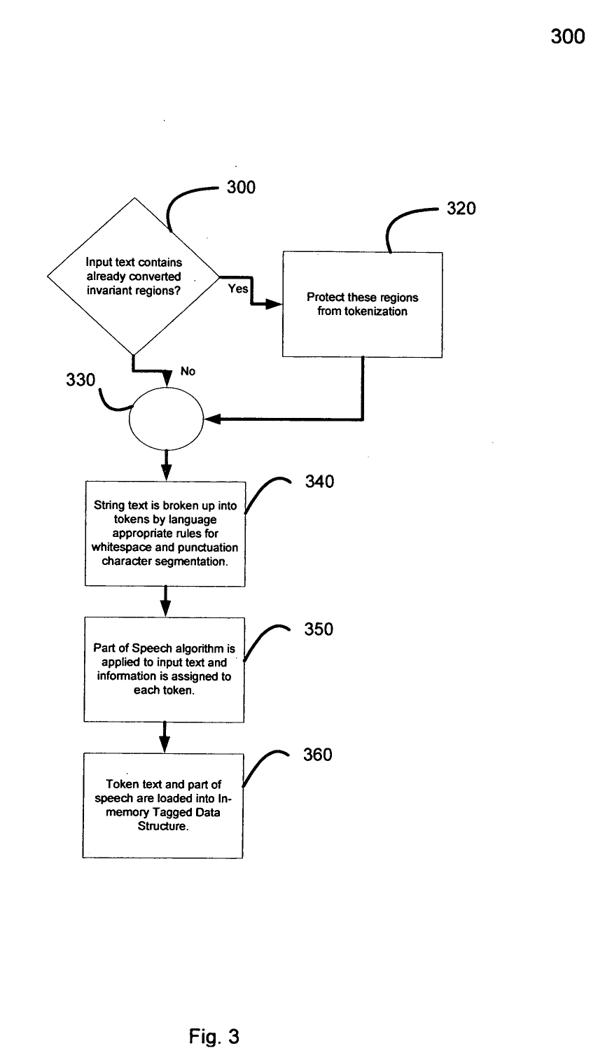

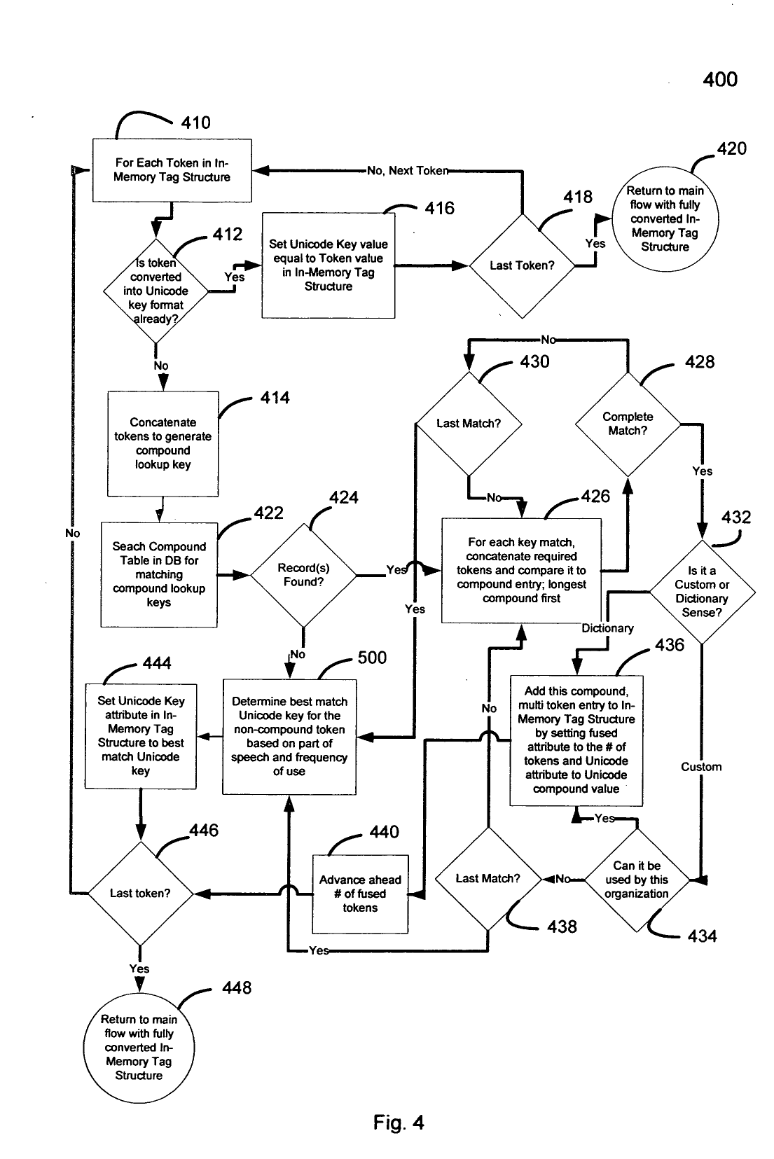

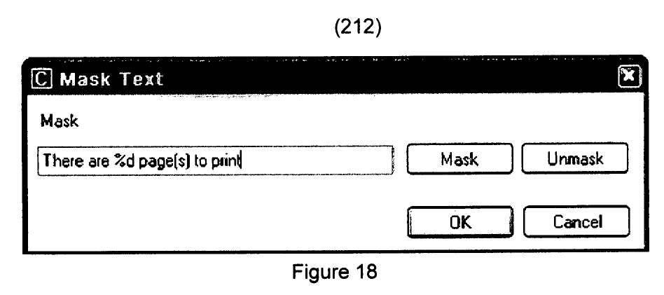

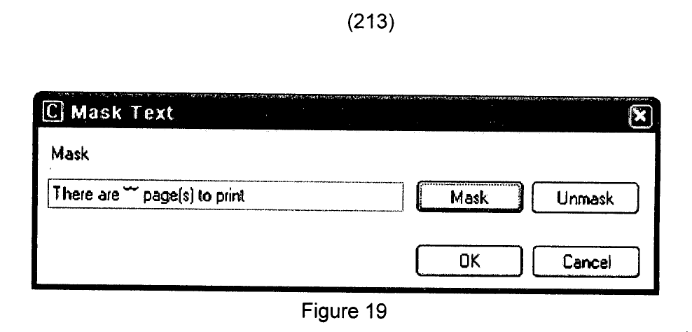

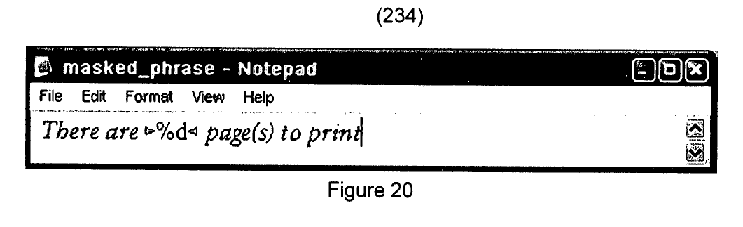

FIG. 2 illustrates the main sense flow 200. The sense flow begins by the user selecting a variable length text string within any editor supporting cut and paste operations 210. The user invokes a particular client function 211 (FIG. 18) or (FIG. 19). The client software automatically pastes the selected text into the clipboard 214. The client software next automatically forwards the clipboard content and session identification number to a web service method 216. The server then verifies that the session is valid 218. For invalid sessions, the server attempts to revive the session 220. Session revival is tested 222. If session revival is unsuccessful, an error message is sent to client software and the user in notified that the session is terminated an login is required 236. The user then logs in using client function 238. Upon valid session or successful session revival 224, the server parses the inbound text string into in-memory tag structure 300 (FIG. 3). Next, the server converts the in-memory tag structure elements to Unicode keys 400 (FIG. 4). The server then assembles the full Unicode representation for inbound text string by concatenating Unicode keys from the in-memory tag structure 230. For this step, keys are separated by Unicode white space characters. The server reverts to original input characters masked by the user employing the client function of the present invention. The server extends the session 232 and communicates a SOAP XML message to the client. The client software receives an XML response, loads the clipboard and pastes content back into the editor 234 (FIG. 20).

FIG. 3 illustrates the algorithm for parsing text string input into in-memory tag structure 300 within the flow schematic of FIG. 2. The input text is checked to discern whether it contains invariant regions already converted 310. If it does contain invariant regions already converted, the regions are protected from tokenization 320. Protected regions and text not converted are processed 330 whereby string text is broken up into tokens by language appropriate whitespace and punctuation character segmentation 340. A Part of Speech algorithm then is applied to input text and part of speech information is assigned to each token 350. Token text and part of speech are next loaded into in-memory tagged data structure 360.

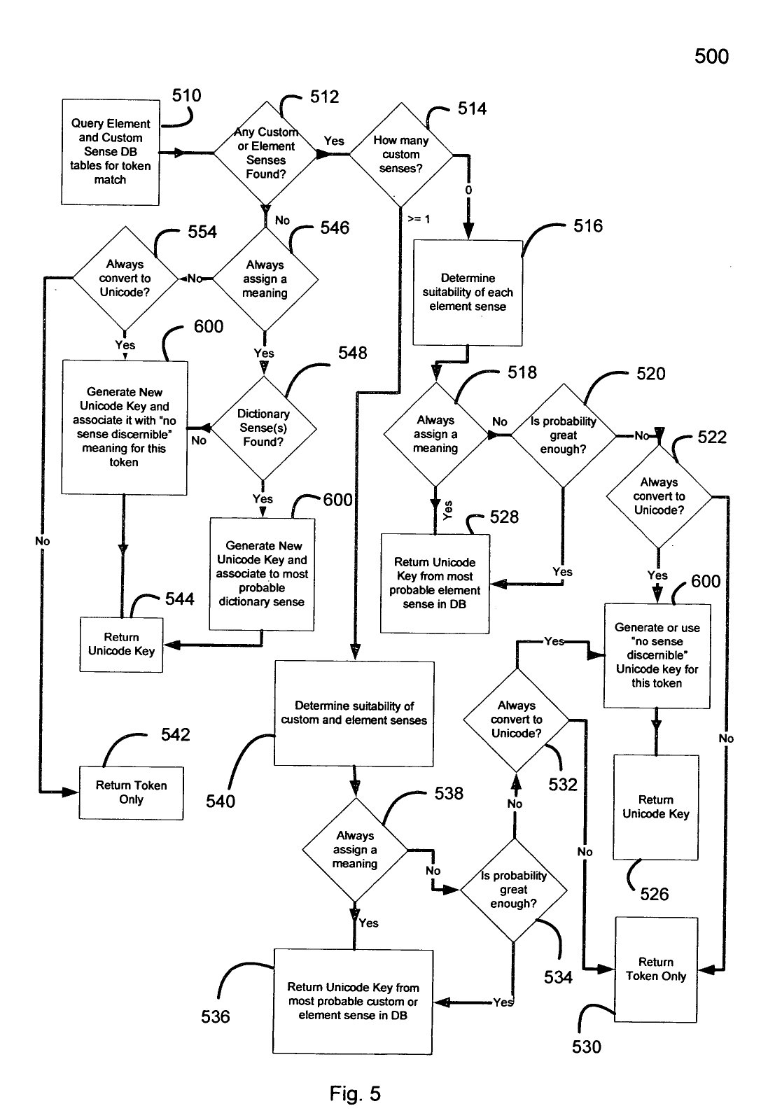

FIG. 4 illustrates a flow chart of algorithmic conversion of in-memory tag structure elements to Unicode keys 400 within the flow schematic of FIG. 2. Each token in the in-memory tag structure 410 is examined to evaluate whether the token is already in Unicode key format 412. For each token already in a Unicode key format, the Unicode key value is set equal to the token value in the in-memory tag structure until all tokens have been so processed 418. Once all tokens have been fully converted to in-memory tag structure, the process returns to the main flow presented in FIG. 2 at block 400. Tokens found not to be converted to Unicode key format 412 are concatenated to generate a compound lookup key 414. The data base compound table is then searched for matching compound lookup keys 422 for records 424. For each key match 426 required tokens are concatenated and compared to the compound entry with the longest compound first to search for a complete match 428. If non records are found, the token is sent to the block 500 (FIG. 5) to determine the best match Unicode key for the non-compound token based on part of speech and frequency of use. The token Unicode key attribute is then set in the in-memory tag structure to the best match Unicode key 444. The token is examined to determine if it is the last token 446. If so, the algorithm flow returns to the main flow diagram of FIG. 2 at block 400. If more tokens remain to be converted, the flow returns to block 410.

As further illustrated in FIG. 4, each incomplete match is examined to see if it is the last match 430. If not, the match returns the compound to the concatenation and comparison block 426 for further comparison. If it is the last match for the compound, it is sent to the block 500 to determine the best match Unicode key for the non-compound token based on part of speech and frequency of use.

From FIG. 4, complete matches from block 428 are examined to determine whether the compound is a custom or dictionary sense 432. Custom dictionary sense compounds are further examined as to whether they can be used by the user specific client organization 434. Usable compounds are added to the in-memory tag structure by setting the fused attribute to the number of tokens and Unicode attribute to a Unicode compound value 436 and advanced ahead to the number of fused tokens 440. The token is examined to determine if it is the last token 446. If so, the algorithm flow returns to the main flow diagram of FIG. 2 at block 400. If more tokens remain to be converted, the flow returns to block 410.

From block 434 of FIG. 4, each unusable compound is examined to see if it is the last match 438. If not, the match returns the compound to the concatenation and comparison block 426 for further comparison. If it is the last match for the compound, it is sent to the block 500 for flow to determine the best match Unicode key for the non-compound token based on part of speech and frequency of use. The token Unicode key attribute is then set in the in-memory tag structure to the best match Unicode key 444. The token is examined to determine if it is the last token 446. If so, the algorithm flow returns to the main flow diagram of FIG. 2 at block 400. If more tokens remain to be converted, the flow returns to block 410.

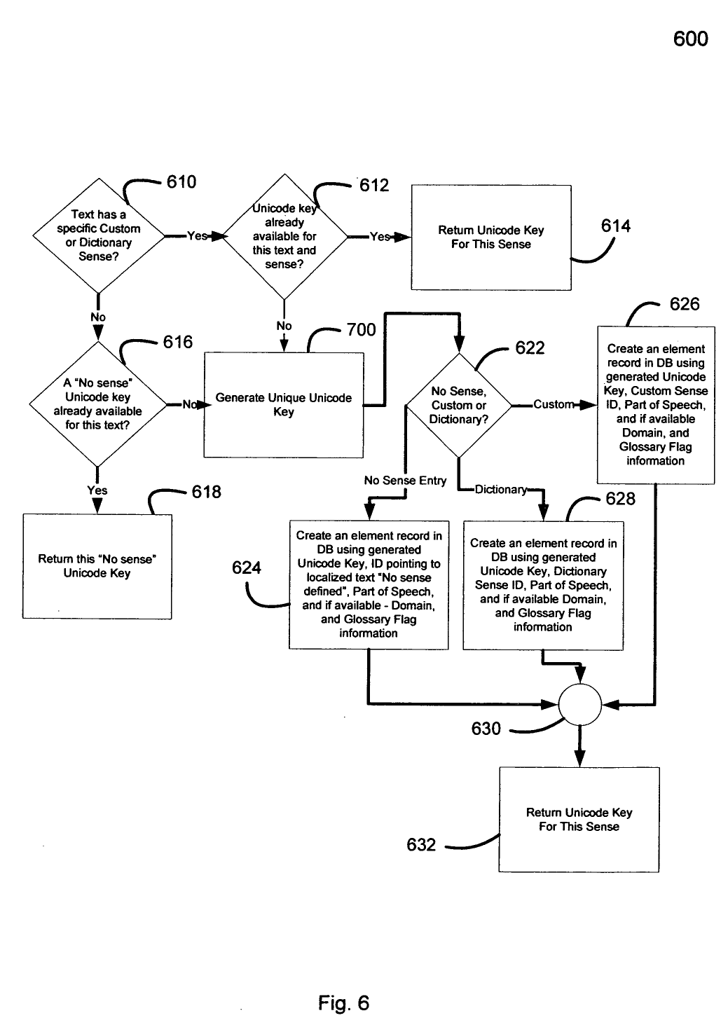

FIG. 5 illustrates a flow chart of algorithmic determination of the best match Unicode key for the non-compound token based on part of speech and frequency of use 500 within the flow schematic of FIG. 4. Each element and custom sense data base table is queried 510 for token matching as to custom or element senses found 512. For each element sense found, the number of custom senses is determined 514. If no customs senses are found for an element, the element sense is examined for suitability 516 and whether meaning is always assigned 518. If meaning is always assigned, a Unicode key is returned from the most probable element sense in the data base 528. If meaning is not always assigned 518, the element sense is examined as to whether probability of sense match to Unicode key in the data base is great enough 520. If so, a Unicode key is returned from the most probable element sense in the data base 528. If not 520, the sense is examined as to whether it would be appropriate to always convert to a Unicode key 522. If so 522, a “no sense discernable” Unicode key is generated or used for the token 600 (FIG. 6) and the Unicode key is returned 526. If not 522, the token only is returned 530.

From FIG. 5, if there are one or more custom senses 514, the suitability of custom and element senses 540 and whether meaning is always assigned 538 are determined. If meaning is always assigned, a Unicode key is returned from the most probable custom or element sense in the data base 536. If meaning is not always assigned 518, the element sense is examined as to whether probability of sense match to Unicode key in the data base is great enough 534. If so 534, a Unicode key is returned from the most probable custom or element sense in the data base 536. If not 534, the sense is examined as to whether it would be appropriate to always convert to a Unicode key 532. If so 532, a “no sense discernable” Unicode key is generated or used for the token 600 (FIG. 6) and the Unicode key is returned 526. If not 532, the token only is returned 530.

From FIG. 5, if no custom or element sense is found 512, it is determined whether meaning is always assigned 546. If not 546, the sense is examined as to whether it would be appropriate to always convert to a Unicode key 554. If so 554, a “no sense discernable” Unicode key is generated or used for the token 600 (FIG. 6) and the Unicode key is returned 544. If not 554, the token only is returned 542.

From FIG. 5, if meaning is always to be assigned 546, it is determined whether a dictionary sense is found 548. If a dictionary sense is found, a new Unicode key is generated and associated with the most probable dictionary sense 600 (FIG. 6) and the Unicode key is returned 544. If not 548, a “no sense discernable” Unicode key is generated or used for the token 600 (FIG. 6) and the Unicode key is returned 544.

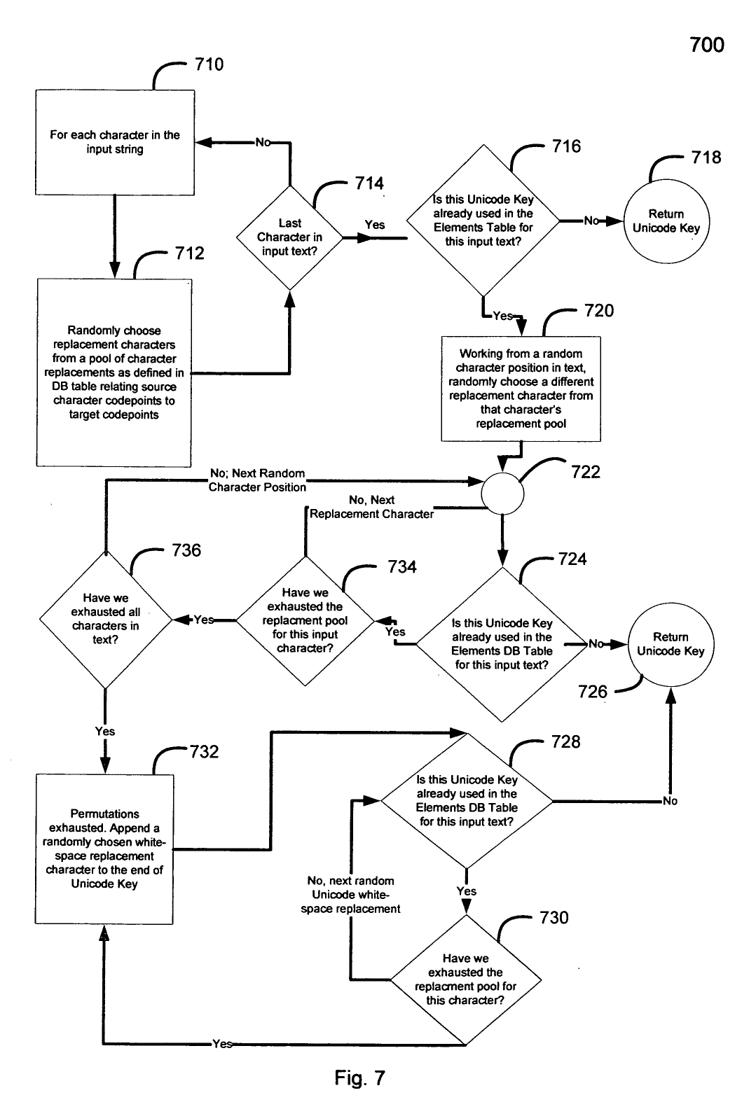

FIG. 6 illustrates a flow chart of algorithmic generation Unicode key sense for the token 600 within the flow schematic of FIG. 5. From FIG. 6, the text is evaluated as to whether it has specific custom or dictionary sense 610. If so 610, it is determined whether a Unicode key is already available for this text and sense 612. If so 612, the Unicode key for the sense is returned 614. If not 612, a unique Unicode key is generated 700 (FIG. 7) and it is further evaluated as to whether it is entered as either custom or dictionary 622.

From FIG. 6 if dictionary 622, an element record is created in the data base using at least one of the features from a group consisting of generated Unicode key, custom sense identification, Brill POS, domain information, and glossary flag information 628 and the Unicode key for this sense is returned 630. If custom 622, an element record is created in the data base using at least one of the features from a group consisting of generated Unicode key, custom sense identification, Brill POS, domain information, and glossary flag information 626 and the Unicode key for this sense is returned 630. If no sense entry is discernable 622, an element record is created in the data base using at least one of the features from a group consisting of generated Unicode key, identification pointing to localized text “No sense defined”, Brill POS, domain information, and glossary flag information and the Unicode key for this sense is returned 630.

From FIG. 6 if not 610, it is determined whether a “no sense” Unicode key exists for the text 616. If not 616, a unique Unicode key is generated 700 (FIG. 7) and it is further evaluated as to whether it is entered as either custom or dictionary 622. If a “no sense” Unicode key exists for the text 616, this sense is returned 618.

FIG. 7 illustrates a flow chart of algorithmic generation of a unique Unicode key 700 within the flow schematic of FIG. 6. For each character in the input string 710 replacement characters are randomly chosen from a pool of character replacements as defined in a data base table 712 linking source language characters with metadata language characters. The function continues until the last character in the input text has been replaced 714. The Unicode key is examined for prior use in the elements table for the input text 716. If not 716, the Unicode key is returned 718. If so 716, from a random character position within the input string text, different replacement characters are chosen from that character's replacement pool in a data base table 720 and the resulting Unicode key is examined for prior use in the elements table for the input text 724. If not 724, the Unicode key is returned 726. If so 724, exhaustion of the replacement pool for the input character is tested 734. If not 734, the next replacement character is selected from that character's replacement pool in a data base table 720 and the resulting Unicode key is examined for prior use in the elements table for the input text 724. If so 734, exhaustion of all input characters in the text is tested 736. If not 736, the next random input character position is selected from the text and a replacement character is selected from that character's replacement pool in a data base table 720 and the resulting Unicode key is examined for prior use in the elements table for the input text 724.

From FIG. 7 if so 736, a randomly choosen, whitespace replacement character is appended to the end of the Unicode key 732 and the resulting Unicode key is examined for prior use in the elements table for the input text 728. If not 728, the Unicode key is returned 726. If so 728, exhaustion of the replacement pool for the input character is tested 730. If not 730, the next random Unicode whitespace replacement character is selected from that character's replacement pool in a data base table 720 and the resulting Unicode key is re-examined for prior use in the elements table for the input text 728. If so 730, a randomly chosen white space replacement character is appended to the end of the Unicode key 732 and the resulting Unicode key is re-examined for prior use in the elements table for the input text 728.

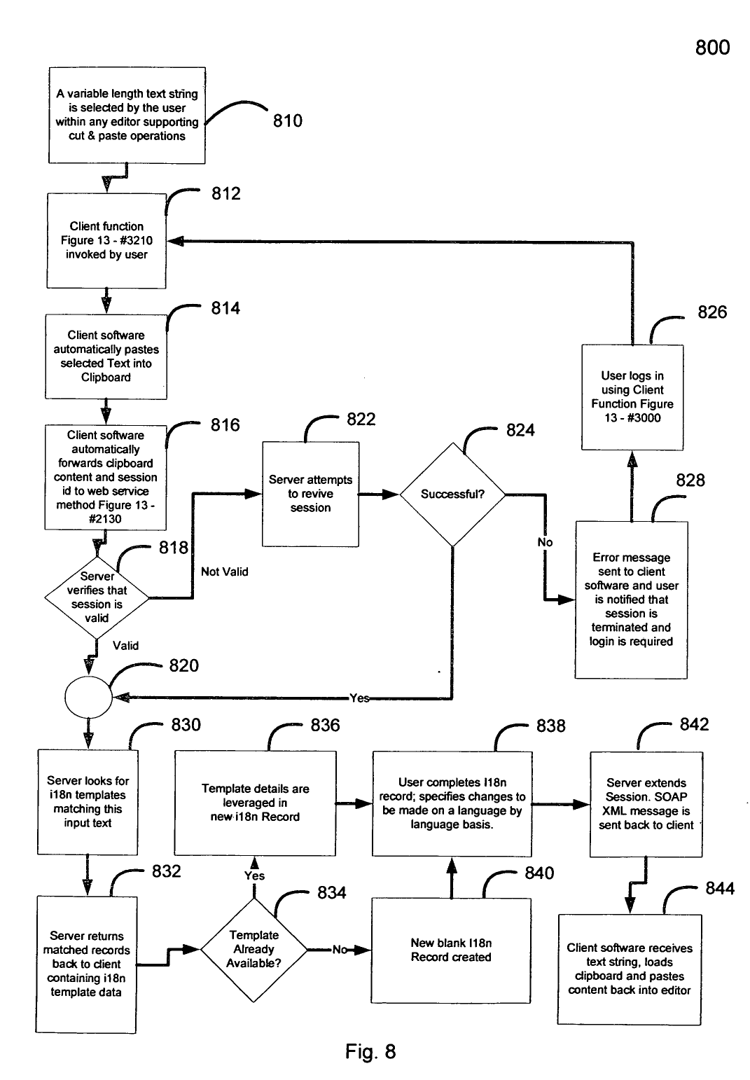

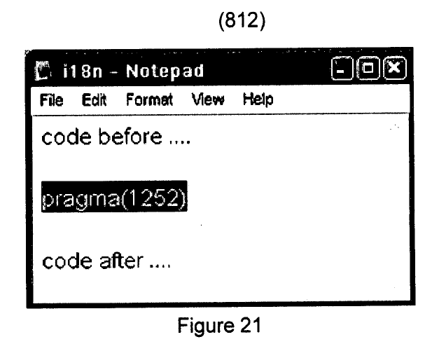

FIG. 8 illustrates a flow diagram depicting an algorithm for variable length text input from cut and paste operations 800. From FIG. 8, a user selects a variable length text string within any editor supporting cut and paste functions 810. The user then invokes client function (FIG. 21) 812. The client software automatically pastes the selected text into clipboard 814. Next, the client software automatically forwards clipboard content and session identification data to the web service method #2130 816. The server then verifies the validity of the session 818. An invalid session 818 is attempted to be revived by the server 820; however, if these attempts are unsuccessful 824, an error message is sent to the client software and the user is notified that the session is terminated and login is required 828. Thereafter, if the user desires to continue, user login is achieved using client function #3000 826.

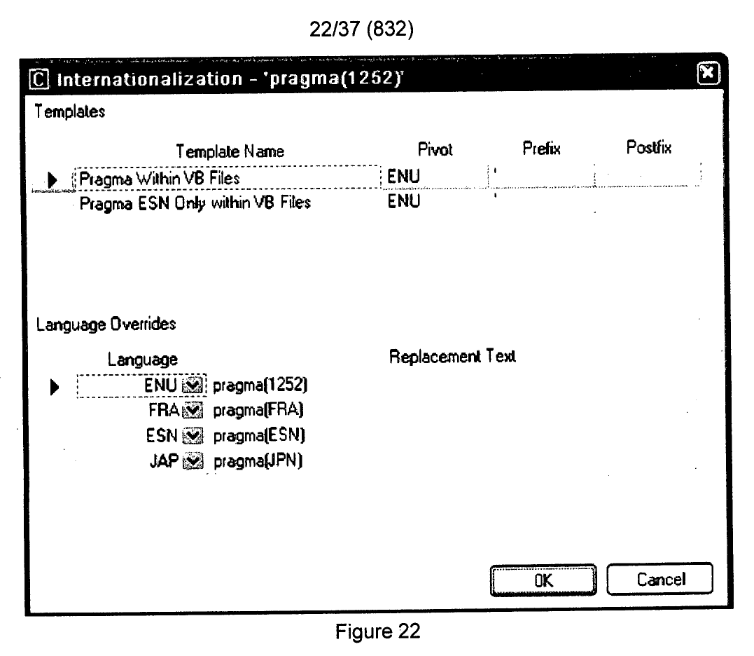

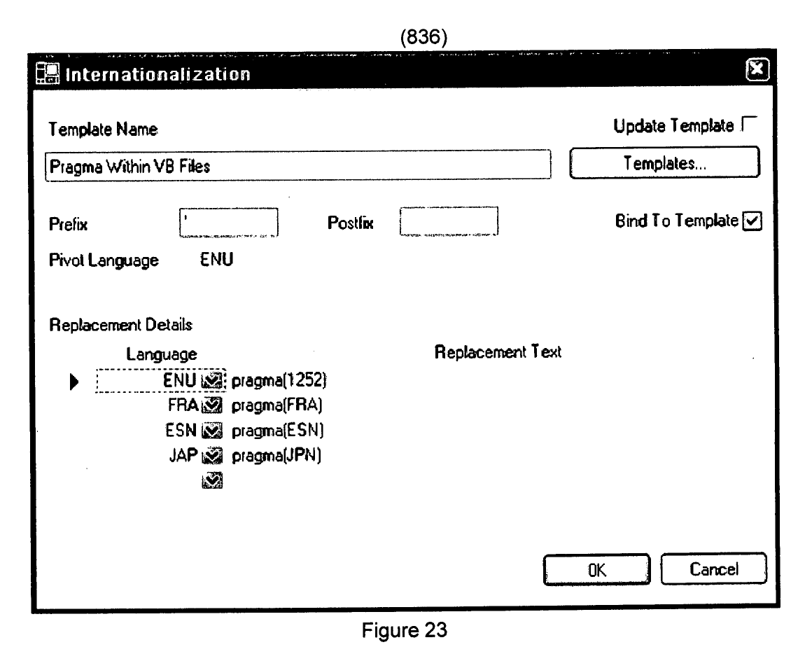

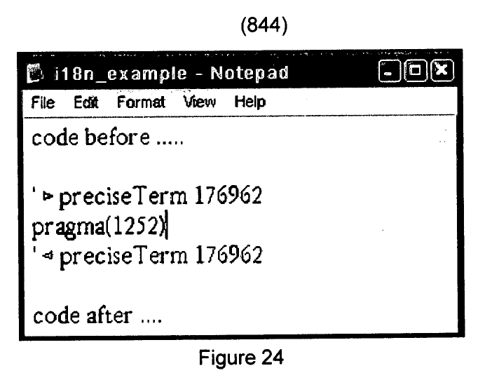

From FIG. 8, for a valid session 820 or successfully revived session 824, the server looks for i18n templates matching the input text 830. Matched records containing i18n template data (FIG. 22) are returned by the server to the client 832, and the data template is evaluated as to whether it is already available 834. If so 834, template details are leveraged in a new i18n record (FIG. 23) 836. The user then completes the i18n record and specifies changes to be made on a language by language basis 838. The server extends the session and a SOAP XML message is sent back to the client 842. The client software next receives a text string, loads the clipboard, and pastes content back into the editor (FIG. 24) 844. If not 834, a new blank i18n record is created 840 and the user then completes the i18n record and specifies changes to be made on a language by language basis 838.

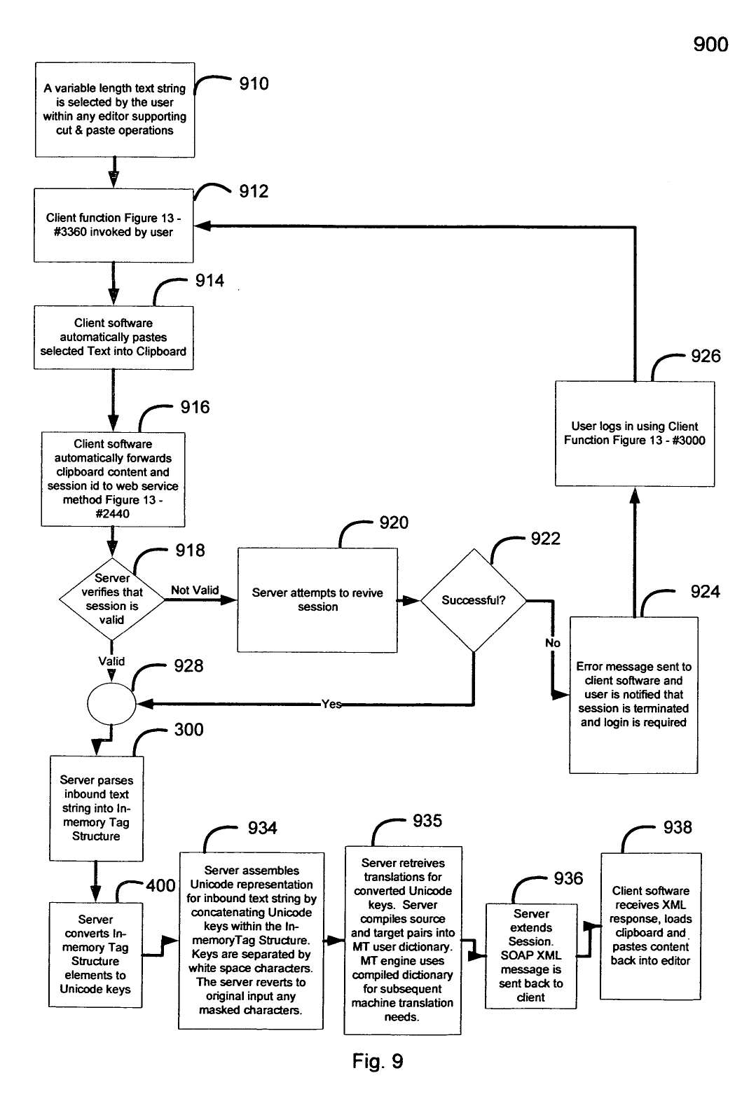

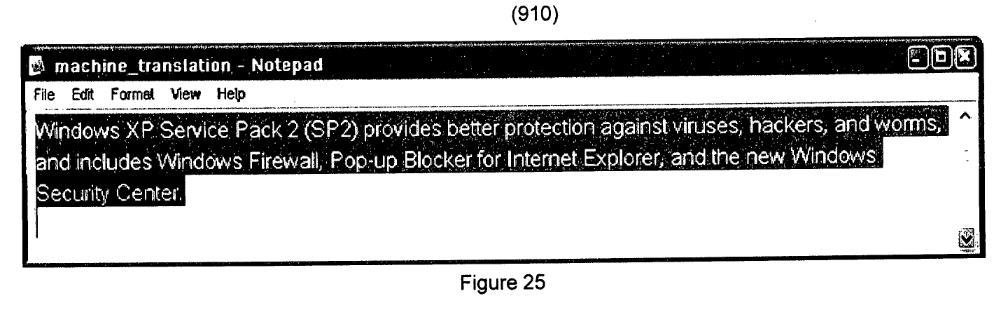

FIG. 9 illustrates a flow diagram depicting an algorithm for variable length text input from cut and paste operations (FIG. 25) 900. From FIG. 9, a user selects a variable length text string within any editor supporting cut and paste functions (FIG. 25) 910. The user then invokes client function #3360 912. The client software automatically pastes the selected text into clipboard 914. Next, the client software automatically forwards clipboard content and session identification data to the web service method #2440 916. The server then verifies the validity of the session 918. An invalid session 918 is attempted to be revived by the server 920; however, if these attempts are unsuccessful 922, an error message is sent to the client software and the user is notified that the session is terminated and login is required 924. Thereafter, if the user desires to continue, user login is achieved using client function #3000 926.

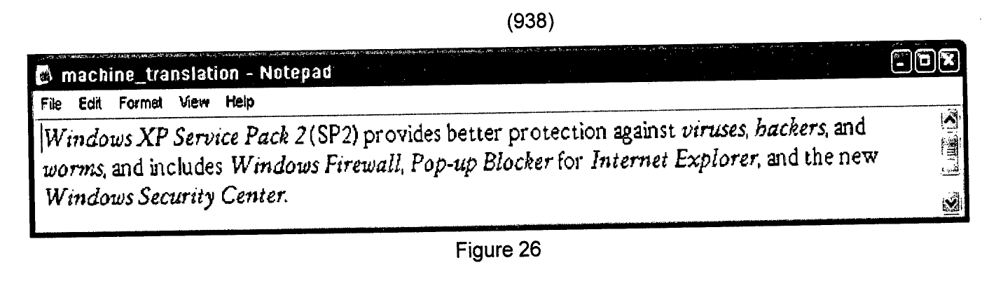

From FIG. 9, for a valid session 928 or successfully revived session 922, the server parses inbound text string into in-memory tag structure 300 (FIG. 3). The server next converts in-memory tag structure elements to Unicode keys 400 (FIG. 4). The server then assembles full Unicode representations for the inbound text string by concatenating Unicode keys within the in-memory tag structure 934. Keys are separated by white space characters and the server reverts to original input any masked characters. The server extends the session and a SOAP XML message is sent back to the client 936. The client software next receives an XML response, loads the clipboard, and pastes content back into the editor (FIG. 24) 938a (FIG. 26) 938b.

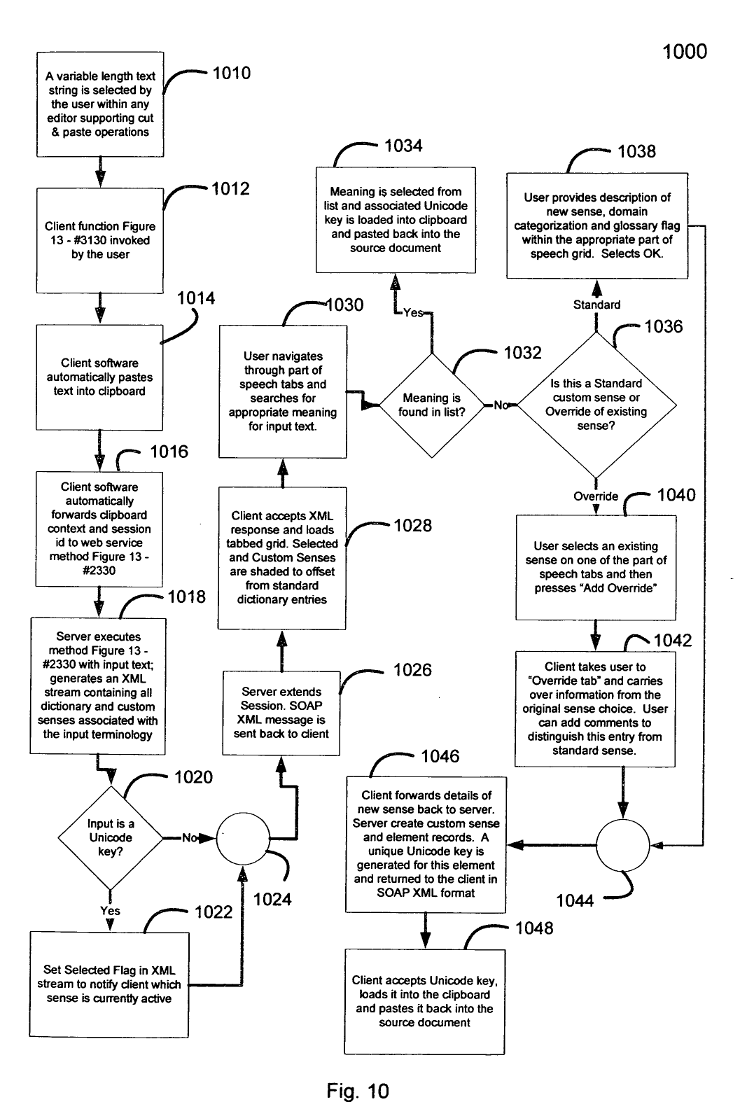

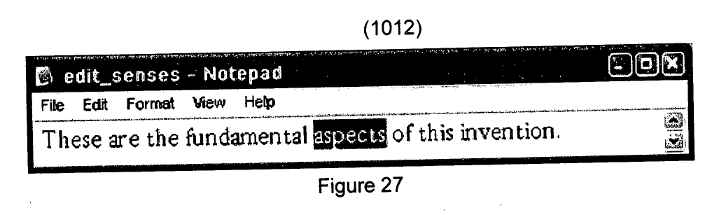

FIG. 10 illustrates a flow diagram depicting an algorithm for variable length text input from cut and paste operations 1000. From FIG. 10, a user selects a variable length text string within any editor supporting cut and paste functions 1010. The user then invokes client function #3130 (FIG. 27) 1012. The client software automatically pastes the selected text into clipboard 1014. Next, the client software automatically forwards clipboard content and session identification data to the web service method #2330 1016. The server then executes method #2330 with input text, generates an XML stream containing all dictionary and custom senses associated with the input terminology 1018.

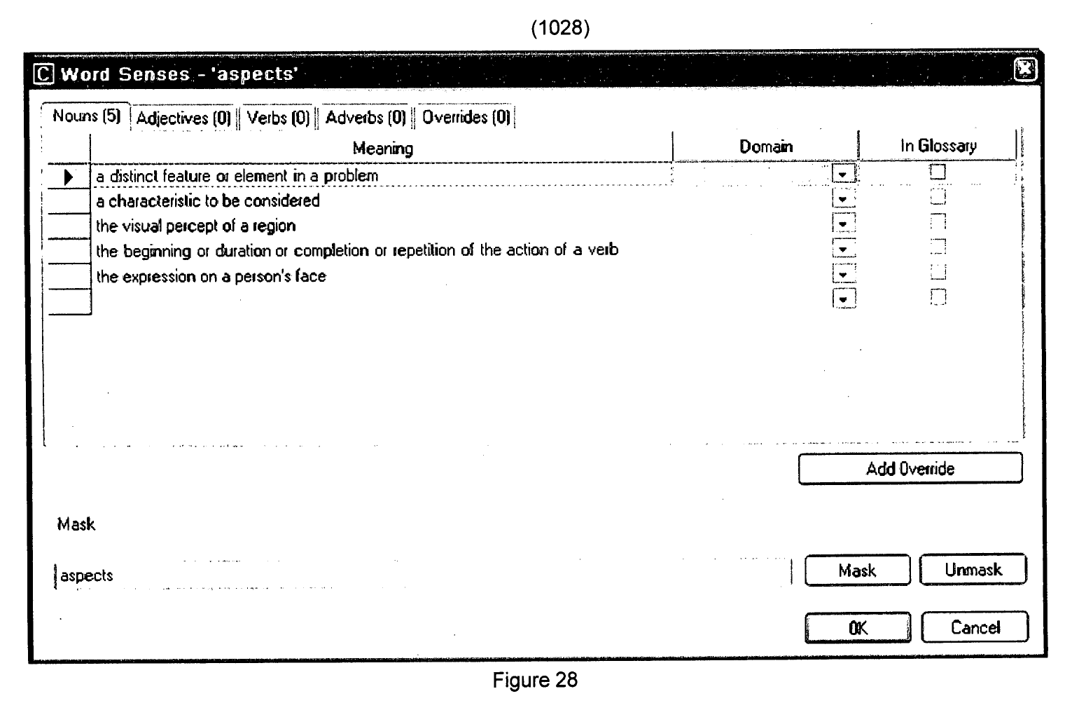

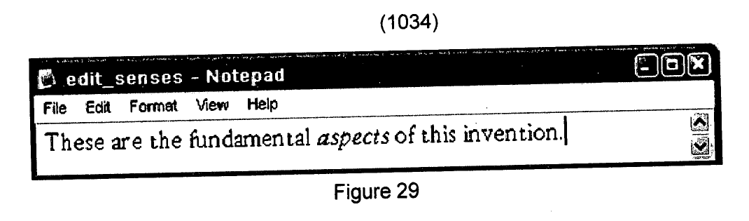

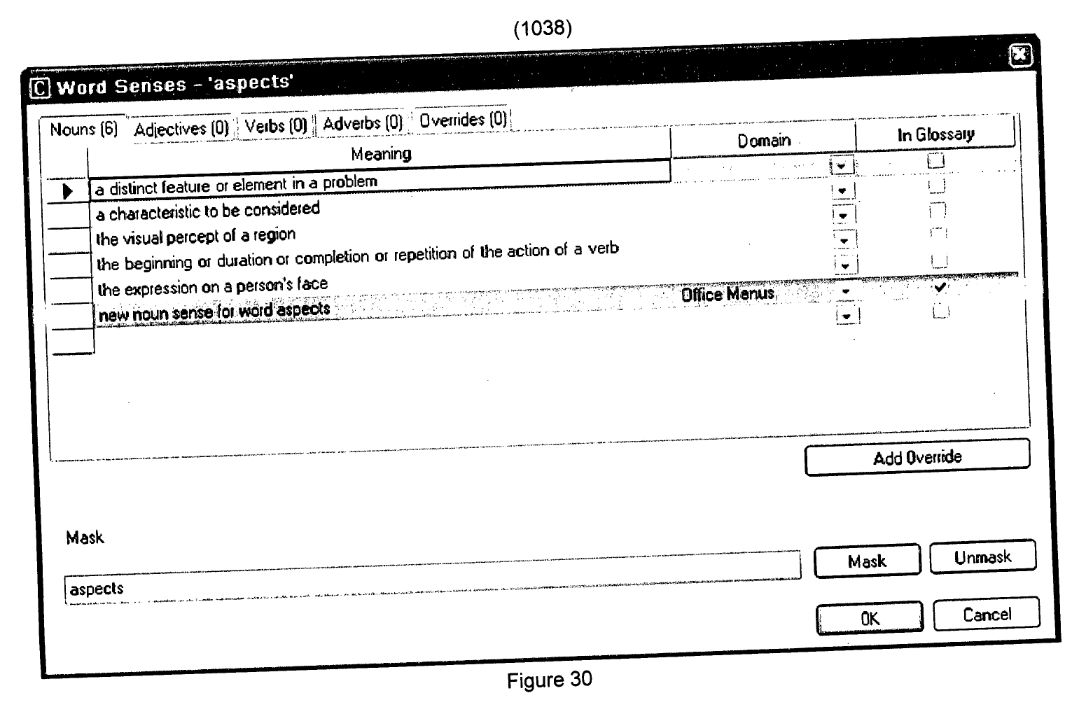

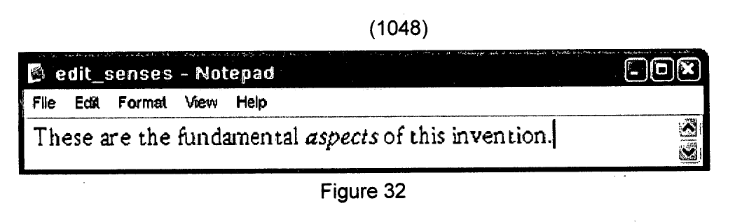

From FIG. 10, the input is examined to determine of it is a Unicode key 1020. If not 1020, the server extends the session and a SOAP XML message is sent back to the client 1026. If so 1020, the server sets a selected flag in XML stream to notify the client which sense is currently active, and the server extends the session and a SOAP XML message is sent back to the client 1026. Next, the client accepts XML response and loads tabbed grid shown in FIG. 28. Selected and custom senses are shaded to offset from standard dictionary entries 1028. Then, the user navigates through the part of speech tabs and searches for an appropriate meaning for input text (FIG. 28) 1030. The meaning is tested for existence in the list 1032. If so 1032, meaning is selected from the list and an associated Unicode key is loaded into the clipboard and pasted back into the source document (FIG. 29) 1034. If not 1032, the meaning is tested as to whether it is a standard custom sense or override of an existing sense 1036. If the meaning is a standard sense, the user provides a description of the new sense, domain categorization, and glossary flag within the appropriate part of the speech grid and selects “OK” from the interactive screen (FIG. 30) 1038. The client forwards details of the new sense back to the server. The server creates a custom sense and element records for the new sense. A unique Unicode key is generated for this element and returned to the client in SOAP XML format 1046. The client accepts the Unicode key, loads it into the clipboard and pastes it back into the source document (FIG. 32) 1048.

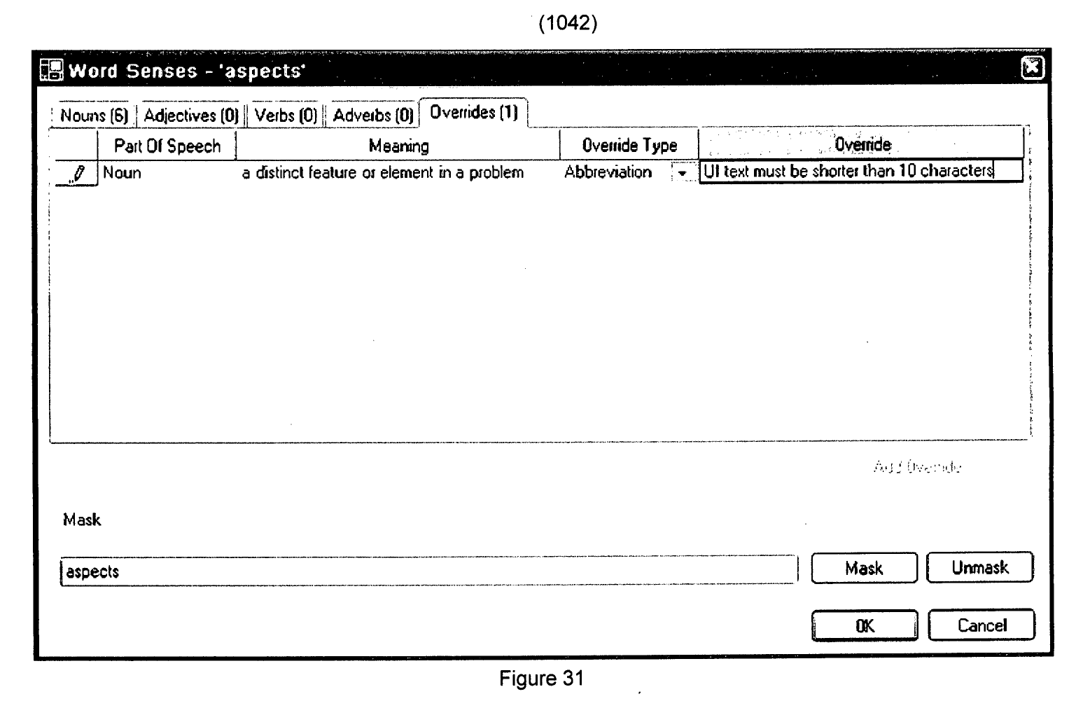

From FIG. 10, if the meaning is an override of an existing sense 1036, the user selects an existing sense on one part of the speech tabs and enters “Add Override” in the interactive screen 1040. The client then takes the user to “Override tab” and carries over information from the original sense choice. User can add comments to distinguish this entry from a standard sense (FIG. 31) 1042. The client forwards details of the new sense back to the server. The server creates a custom sense and element records for the new sense. A unique Unicode key is generated for this element record and returned to the client in SOAP XML format 1046. The client accepts the Unicode key, loads it into the clipboard and pastes it back into the source document (FIG. 32) 1048.

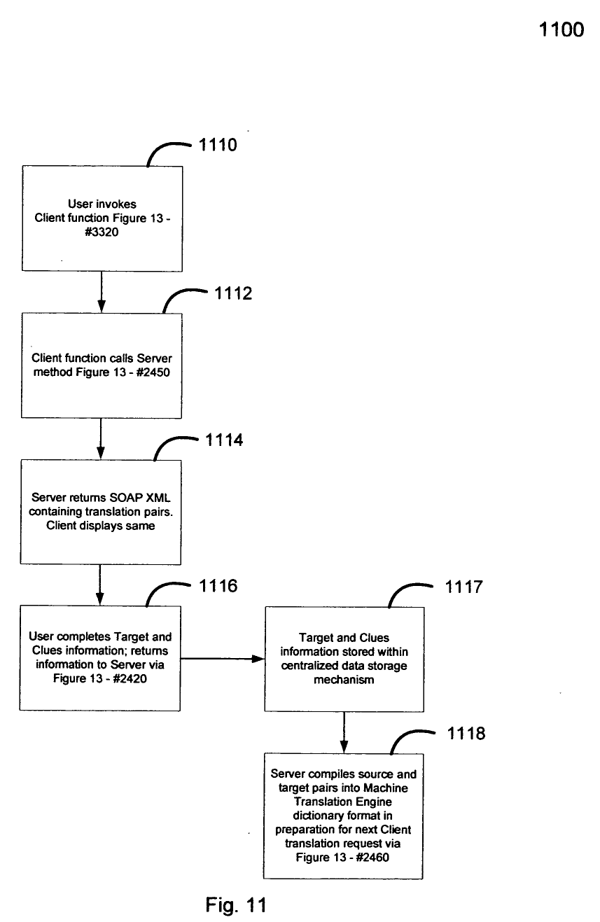

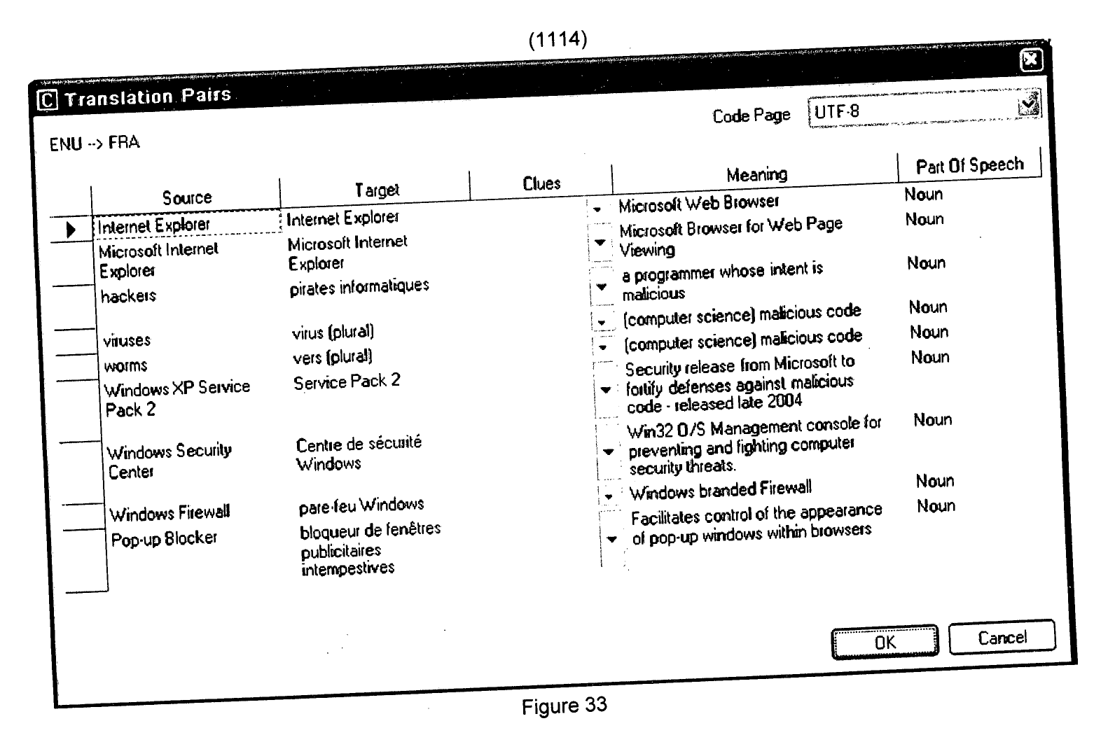

FIG. 11 illustrates a translation flow diagram 1100 for an embodiment of the present invention. From FIG. 11, a user first invokes client function #3320 1110. The client function then calls the server method #2450 1112. The server returns a SOAP XML message containing translation pairs and the client displays the same (FIG. 33) 1114. The user next completes target and clues information and return the input information to the server via function #2420 1116. The server then forwards source and target pairs to machine translation engine in preparation for the next client translation request via function #2460 1118.

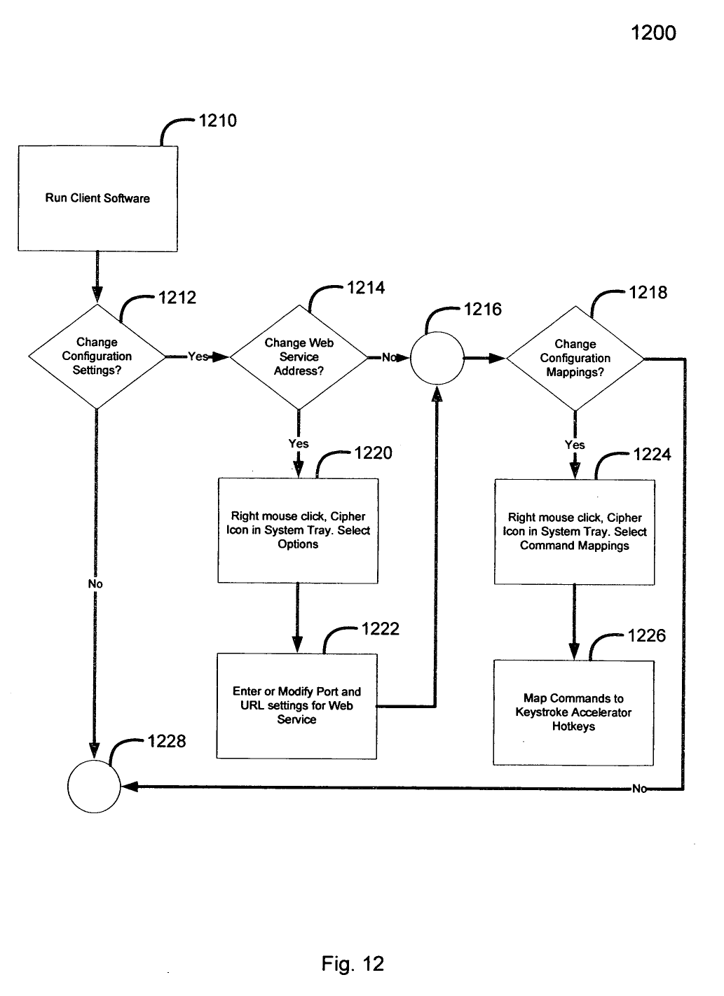

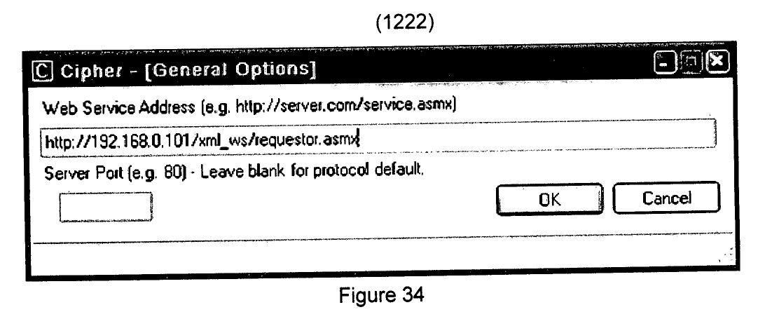

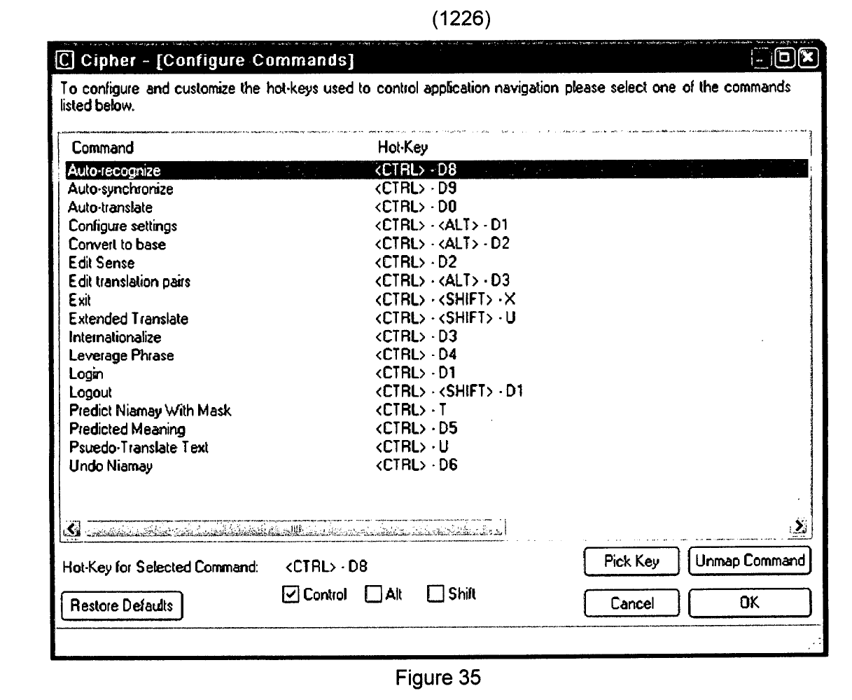

FIG. 12 illustrates a flow diagram for configuration of the software client 1200 for an embodiment of the present invention. From FIG. 12, a user runs a client software function 1210. Client configuration settings are examined for any changes 1212. If configuration settings have changed, the client's web service address is examined for change 1214. If the client web service address has changed, the user selects system options 1220 and enters or modifies port and URL settings for the new web service 1222 (FIG. 34). If there has been no change of web service address or after new port and URL settings have been entered 1216, configuration mappings are examined for any change 1218. If the configuration mappings have changed, the user selects command mappings option 1224 and maps commands to keystroke accelerator hotkeys 1226 (FIG. 35). If there are no changes to configuration settings or configuration mappings, the client software returns 1228 to the main sense flow 200.

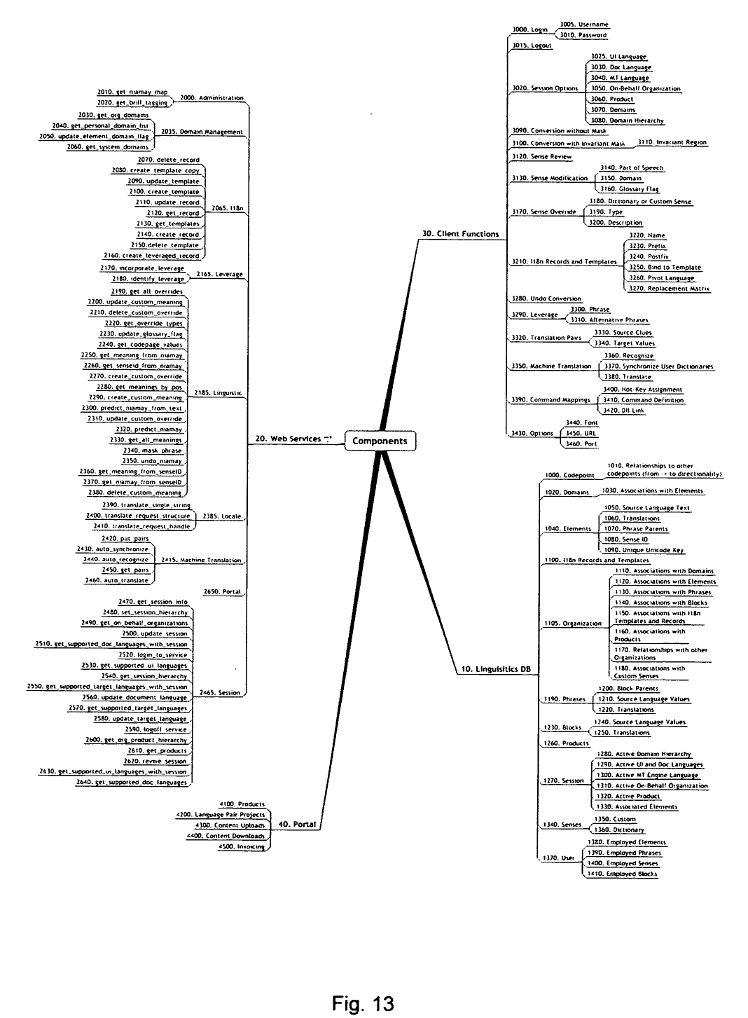

FIG. 13 is an architectural schematic diagram of the system of an embodiment of the present invention for internationalization and localization of linguistic content depicting principal system components of linguistics database, web services, client functions, and portal, and inter-related multiple sub-components for each component.

Replacement Algorithm

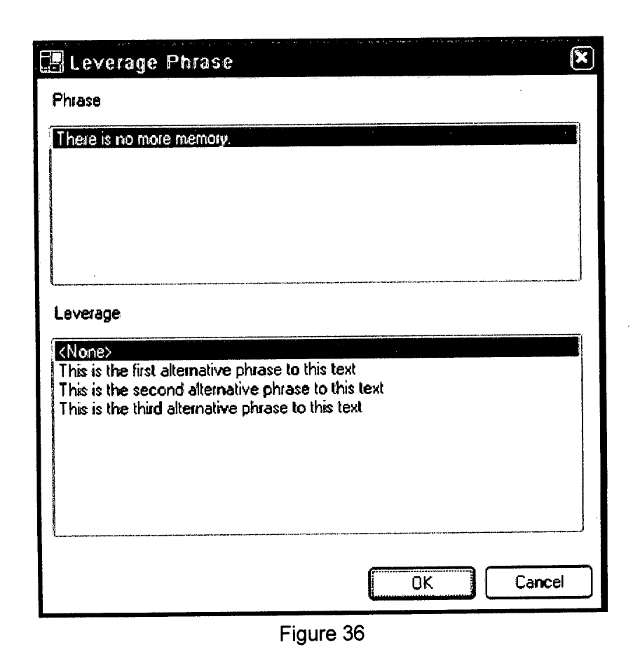

There is no mathematical formula for character replacement. Rather, a set of character substitutes were initially visually determined for each 1252 character. The selection was based on visual similarity to the 1252 character. In addition to the aforementioned 1252 character replacements, certain other Unicode characters have been added to the pool of characters seen in converted text. These mappings are added to the data base in order to support generation of a unique code whenever the available substitution pool is insufficient to uniquely define a word and its meaning. This is the case with a short word like ‘be’ that has many meanings (particularly verb meanings) and the replacements for the characters b and e are exhausted before all meanings are assigned unique replacement strings. In such cases, uniqueness is obtained by pre-pending or appending extra characters to the input string. In another enhancement to the language, specific Unicode replacement characters have been assigned extra meaning. For example, the character \u9251 has been used to tie together tokens within a compound name or phrase such as “black hole” or “outer space”. Between the words “black” and “hole” or “outer” and “space” there is a \u9251 character after conversion which unambiguously informs translators and machine translation engines that these tokens should be translated as a compound noun or phrase, not individually. In another embodiment of the invention, there are numerous Unicode whitespace characters that replace original ANSI whitespace \u0020. In practice this feature allows users to convert ANSI whitespaces in a specific way to attach metadata at sentence or paragraph levels. With meta-categories embedded within source text, search and retrieval for content by meta-category becomes feasible. Content is re-used more consistently resulting in more standardized terminology and greater re-use of existing translation assets. FIG. 36 illustrates an embodiment of the present invention where, via cut and paste interoperability, alternative options for expressing like meaning and nuance at the sentence level are presented to an end-user.

To generate any unique string, the selection of each of the characters is random and once all characters have been assigned replacements, a look up is made to make sure that the replacement string is indeed unique, FIGS. 2, 4 and 7. If it is not, the system will again cycle through randomly generated characters to come up with a suitable unique replacement.

Character replacement is not limited to characters with visual similiarity to original source characters if custom fonts are used since custom fonts can map any character codepoint to a glyph which a user will understand.

The client add-ins, regardless of whether they are embedded within rich development environments like Visual Studio or eclipse or within any content editor via web-services cut and paste based implementations, support the following categories of functionality: Login, Session, Organization, Domains, Products, Translation, Dictionary Sense, Custom Sense, Sense Override, 118n Template, 118n Record, Leverage, Navigation, Portals/Translation Workbench, Machine Translation, and Custom Fonts. Specifically these categories are implemented by use of the web service function calls as documented in FIG. 13.

Login

Users are authenticated and authorized to utilize web service functions. The login module, as depicted in FIG. 1, allows a qualified user to access the system and methods of the present invention by identification through a user name and/or a secure password access. The module also serves to end a current session by user log off. Functionality in this module is not unique to the methods and system of the present invention and, thus, is not discussed further.

Session

Login sets a user's session parameters to those of the user's last session and returns a user to that set of session information last accessed by the user unless otherwise instructed to make changes, e.g., FIGS. 1 and 2. For an embodiment of the present invention, session parameters are: UI language, Document language, Organization, and Product, FIGS. 15 and 16.

Understandably, the parameter ‘UI language’ controls the language in which the client UI text is displayed.

‘Document language’ controls the sense dictionaries that are loaded and used to interpret document text. In the general case, this language may be different from the UI language—users can be working on a French document within an English language editor.

The organization indicates on whose behalf the user is working. As this individual may be a third party contractor who works on multiple products for multiple organizations, it is important that user sessions are distinguished since, as shown, these session parameters directly control glossary visibility and prediction algorithms.

The last session parameter of note is Product and this permits the session to be customized for a specific product. The organization and product selections influence domain hierarchies.

Sessions are timed out automatically after in-activity; a value within the session record must be updated in order for the session to remain valid. Server calls ensure that this is done as a manner of course and no user interaction is required, other than simple use, to maintain connectivity.

Organization

The service calls under this module can return a list of organizations on whose behalf the user is authorized to access the system. Users select from this list and call update_session (FIG. 13-#2500) to make appropriate changes which update a glossary flag on the organization element table, FIG. 13.

Domains

Domains are subject matter categories that may be used to organize and classify meanings. Prediction algorithms are used to guess word sense and these algorithms are initiated whenever a user flags a region of document text and invokes conversion into the invention's language. Prediction algorithm outcomes are influenced by the domain hierarchy currently active within the session. A word meaning with a domain attribute matching a domain high in the active hierarchy will have a stronger change of pre-selection than one lacking such an attribute.

The domain module begins by the user setting the session hierarchy and getting the organization master domain list, e.g., FIGS. 1 and 17. The association between the element identification and the domain identification is updated. The personal domain list, session organization and product combination hierarchy, and current session hierarchy are provided, and names of domains in the UI language are returned.

Products

Products are dependent on organizations and thus users choose a product only after an on-behalf organization has been selected. The combination of organization and product pre-default a domain hierarchy. Within the add-in, users may choose to modify this system-administered domain hierarchy, as shown by example in FIGS. 1 and 16.

Translation

This module performs the mapping of original source characters to non-original source characters and ensures that the text that replaces the original is unique and specific to the meaning level. Each specific meaning of a word or group of words (i.e. outer space) will return a unique series of non-1252 characters, as depicted in FIG. 5. In rare cases, the series of characters that are returned may be longer than the original text. This would be necessary if all character substitution combinations have been exhausted before covering all possible meanings of the word or group of words. The system automatically appends visually insignificant characters to the end of the word(s) in order to ensure uniqueness at the meaning level.

While a specific system translation mapping is returned for each given character input in the translation module, text and text substitutions are predicted based on active domain preferences, and these predictions support masked input. The module provides a Part of Speech tagging structure and case sensitive reversal of the system translation.

Senses

There are three types of senses.
1. Dictionary senses derive from a licensed database.
   (Dictionary)
2. Custom meanings are created by users in response to a gap in the coverage of the licensed database. (Custom)
   These custom meanings are associated with a single organization.
3. Finally, sense overrides do not delineate differences of context; rather, they drive differences in implementation. They can be used to give translators specific instructions on need for abbreviation in translation. (Overrides)

Dictionary and custom senses are displayed on client UI tabs organized by part of speech, FIGS. 5 and 6. Sense overrides are displayed in a separate tab.

Each sense may have one domain associated with it as well as a glossary flag indicator.

A sense or context can be associated to more than one word such as in the case of “Internet Explorer” or “Black Hole”. Even phrases that have one context can be associated via a custom meaning.

As displayed in FIG. 31, Overrides possess a separate tab visible within this dialog allowing users to view the overridden implementations for word/meaning combinations.

Internationalization Templates

The methods and system of the present invention assert that engineering organizations will spawn language versions out of a single base file. This is possible if enough intelligence is embedded within the base file to create all language versions. However, not all differences in language files are linguistic in nature. Thus, simply converting text will not resolve situations where code blocks need to be replaced in certain languages. To embed these types of instructions, the methods and system of the present invention use the internationalization template and internationalization record mechanisms, FIGS. 8, 22, and 23.

Internationalization Records

Internationalization Records are created in situations where code blocks must be replaced in a specific way, language by language. Normally, the code block itself in the base file cannot be modified in any way or else its build scripts will fail. Therefore, within the base file, comments invisible to the complier are used to bracket the targeted code block. These comments facilitate extraction and re-insertion of appropriate code blocks by language. Internationalization records may inherit from templates. The templates are simply storage mechanisms for internationalization solutions that are so commonplace that their re-entry would be cumbersome to the end-user, FIG. 8.

Masks

Masking permits a developer to enter text as a translatable block yet mark certain regions within this block as independent of locale. As such, masking is yet another method whereby translators are given explicit instructions on author intent. Masking circumvents a pernicious challenge within the localization industry—that of over-translation. In FIGS. 2, 18, 19, and 20, for example, the language neutral “% s” placeholder can be protected from translation.

Leverage

The leverage module permits users to leverage from previously entered and translated phrases expressing similar meaning or context. The leverage module will accept sentences or short phrases that have been previously converted into non-original source characters. Using the context metadata that accompanies the text, lookups are facilitated within the sense dictionary to permit users to see a list of previously entered phrases that express near or identical meaning to the input, FIG. 36. The final choice of substitution is up to the user and, once selected, the substitution text is returned to the authored document.

Navigation

This module is client side functionality that permits the backwards and forwards navigation through a document matching non-original source text strings corresponding to distinct meanings. The functionality includes a call to the web methods that return the meaning of the found text. This meaning is displayed to the user in some UI window.

Portals and Translation Workbench

Once metadata in the form of the non-original source text strings and i18n comment blocks are added to a file, the file is ready for automatic translation processing. Translation processing culminates in a base file converted into all required languages. As mentioned, the intent of the additional authoring steps is to add sufficient instructions within the base file to facilitate conversion of that file into all subsequent language versions.

The portal component to the methodology covered by the method of the present invention permits the upload of appropriately authored documents and the download of language file analogues. Language versions are generated based on project requirements as specified by account managers overseeing translation. Account managers act on products and projects. Products are unique combinations of product name, version and platform. Projects are combinations of products and language pairs. Projects include enough schedule timing data to direct the automatic generation of language versioned files triggered when the system senses upload of a corresponding file or set of files. Uploaded files are associated with products. Using the product to project, one to many relationships, language files are automatically generated and made available to the engineering organizations that need to incorporate language versions of their base files back into their build systems.

The portal component also facilitates communication between the system administrator and translators. The portal posts help wanted advertisements to translators when new content is recognized as needing translation. Translators can negotiate and finalize pricing details within the context of the portal. Once terms are agreed by both parties the translations jobs become active and files are furnished to translators containing text in need of translation. The file format of these files is rich and contains all metadata associated with text at the time of authoring. This metadata includes the meaning, part of speech, glossary flag, and domain categorization of the text needing translation. If historical (past translations) are available for a particular element within a phrase, that leverage information is provided to the translator to foster standardization of translation.

Translators complete work on these intermediary files and then upload completed files into the portal. When upload is complete, processing is triggered which inserts file content back into the terminological database. At this point, this content is ready for use when an authored document arrives that requires this translation.

In addition to translation content, the returned intermediary files may contain instructions on defects found in current translation or source authoring. It may be clear to a translator, for example, that the meaning that the author has associated with text is incorrect. Provisions for feedback are embedded within the intermediary file format and their input is supported by the third main component in the methodology, the translation workbench.

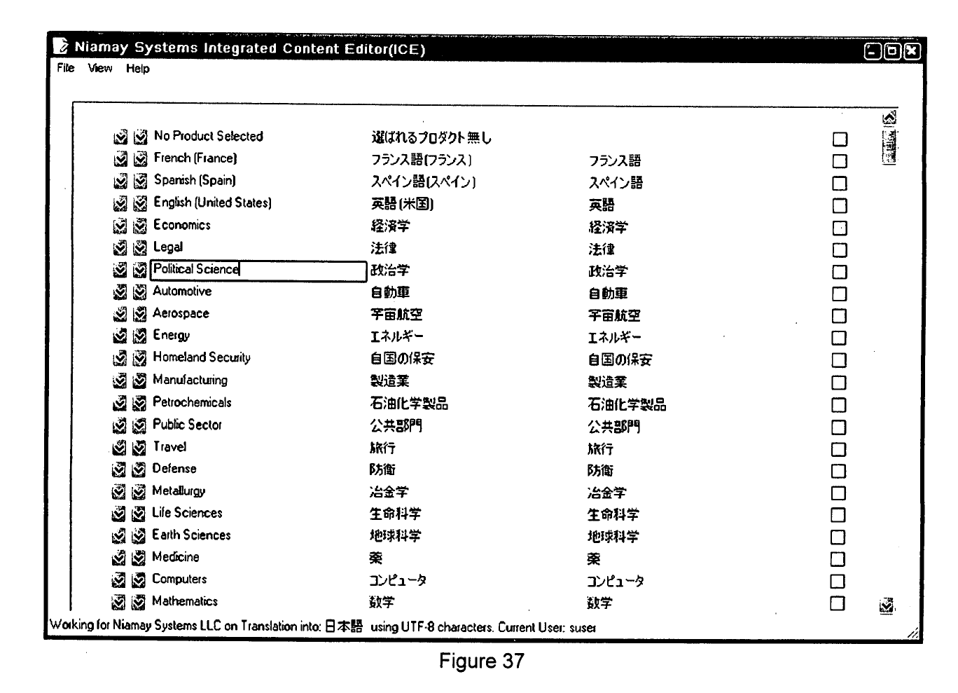

The translation workbench is a thick client application intended to be used by translators and reviewers of source and translated text. The data within the workbench is presented hierarchically. At the highest level, users are presented with a series of blocks of text and their associated translations. These blocks are broken down or segmented into components and the source/target pairs associated with these segments are visible in the sub layer. For source terms in this level, when previous translations are on file, they are available via drop downs and thus, capable of leverage by translators. Entered or selected translations at this level will populate a text field labeled hints at the block level above, FIG. 37. After the translator completes all required input at this sub level (translation, gender, and plurality as appropriate for nouns; translations for other parts of speech), they return to the block level to complete the target column for the phrase. The hints column automatically populated from target entries at the segment level, provides specific context to aid the translator in completing the phrase.

Blocks of text within the authored documents that require internationalization only are handled without output to the translator workbench. The only information sent to the translator is that text which is localizable and presented on the UI. Internationalization blocks are handled purely via database replacements as specifically instructed by the programmer coding the software and adding the content, FIG. 12.

Sequencing roster architecture of the system modules of the present invention discussed above are further illustrated in FIG. 13.

The methods and system of the present invention are particularly suitable for applications supported by computerized systems and distributed databases with extensive search capabilities provided by a packet network, such as the Internet or a corporate intranet (including those made available using browser technology in conjunction with the World Wide Web), or in a stand alone mode within a user's customized environment.

Machine Translation

Modern day, rules based machine translation engines use customized dictionaries which map important source terminology to target translations to improve output accuracy. In current practice, user dictionaries are prepared ahead of document machine translation and are configured and tuned for a set of documents, rather than any one in particular.

User dictionaries can be customized on a document by document basis when metadata is:
1. stored concomitantly within text,
2. points to specific source and target pairs within a multilingual terminology data storage mechanism, and
3. can readily be decoded from its metadata format into its source character format.

It is clear from prior art that machine translation of unambiguous terminological units within source significantly improves the quality of machine translation output as sentence level semantic complexity is reduced. With concomitant metadata, user dictionaries can be based on lookups which combine Unicode metadata and source text to distinguish meanings of identically spelled words like “cast” the noun meaning—actors in a play from “cast” the noun meaning—plaster cast applied around a broken bone.

In the current embodiment, metadata, source and translation pairs are transmitted to a web service which compiles content into a user dictionary format compatible with the Systran machine translation engine. In subsequent requests made to this engine to furnish translations, unambiguous text and meaning are recognized within source and appropriate translations are folded into the machine translation output.

Custom Fonts

Custom fonts enable a controlled mapping of Unicode codepoints to user interface glyph representations. Within custom fonts, a codepoint that renders to a user interface as a Chinese ideograph by international convention and agreement could be re-mapped to a Greek Omega glyph representation. In this way, the true codepoint behind the presentation layer is hidden if font is controlled.

Text appearance can be altered arbitrarily. For example italics could replace original non-italicized content to denote a change in metadata underlying linguistic content. Font handling is built into every modern computer operating system and controlled at an application level where content is created, modified or displayed. Thus, concomitant metadata can be hidden from the user within any editor with a standard font control mechanism by providing a custom font.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

1. A method for embedding metadata objects concomitantly with linguistic content stored on a data storage medium and accessible by a computer processor, the method comprising the steps of:
transmitting a user-defined, variable length text string within a client based product and function that supports cut and paste operations within its editor to the processor;
parsing linguistic tokens within the text string into an array of in-memory tag elements;
deriving a metadata object composed exclusively of Unicode codepoints which link to an element record in a data storage medium;
concatenating derived metadata objects into a plurality of meta-data objects;
returning the plurality of metadata objects to the client based product and function; and
controlling the user interface appearance of the plurality of metadata objects within the client based product using custom font;
whereby the client based product and function is not changed or controlled by the method.

2. The method of claim 1, further comprising the step of constructing document versions from the plurality of metadata objects.

3. The method of claim 2, further comprising the step of refining document versions including enhancing the plurality of metadata objects and their associated element records within the data storage medium.

4. A system for embedding metadata objects concomitantly with linguistic content stored on a data storage medium and accessible by a computer processor, the system comprising:
a data input device initiating a user-defined, variable length text string session within a client based product and function module that supports cut and paste operations within its editor to the processor;
a tag structure module to parse linguistic tokens within the text string into an array of in-memory tag elements;
a Unicode key module to derive a metadata object exclusively of Unicode codepoints that link to an element record in the data storage medium; and
a plurality of metadata objects module for concatenated derived metadata objects;
whereby the client based product and function module is not changed or controlled by the system and the appearance of the plurality of metadata objects within the client based product and function module is controlled by custom font.

5. The system of claim 4, further comprising a module to construct document versions from the plurality of metadata objects.

6. The system of claim 5, further comprising a module to refine document versions and to enhance the plurality of metadata objects and their associated element records within the data storage medium.

7. A computer-program product for use in a system having at least one data communications network, at least one content server connected to the data communications network, a data storage medium, at least one computer processor, and at least one end user electronic display device connected to the data communications network, wherein the network is a distributed hypermedia environment, the computer program comprising a computer usable medium having computer readable program code physically embedded therein, the computer program code further comprising:
computer readable program code to initiate a user-defined, variable length text string within a client based product and function to the processor;
computer readable program code to parse linguistic tokens within the text string into an array of in-memory tag elements;
computer readable program code to derive a metadata object composed exclusively of Unicode codepoints which link to an element record in a data storage medium;
computer readable program code to concatenate derived metadata objects into a plurality of meta-data objects; and
computer readable program code to return the plurality of metadata objects to the client based product and function;
whereby the client based product and function module is not changed or controlled by the program code and the appearance of the plurality of metadata objects within the client based product and function module is controlled by custom font.

8. The computer program product of claim 7, further comprising computer readable program code to construct document versions from the plurality of metadata objects.

9. The computer program product of claim 8, further comprising computer readable program code to refine document versions and enhance the plurality of metadata objects and their associated element records within the data storage medium.

10. A method for managing terminology and facilitating efficient internationalization and localization of linguistic content contained in a document set stored on a data storage medium and accessible by a microprocessor, the method comprising the steps of:
transmitting a user-defined, variable length text string within a client based product and function to the processor;
parsing the text string into a converted in-memory tag structure;
deriving a Unicode key from the in-memory tag structure;
embedding a plurality of data storage medium targets to the converted tag structure;
leveraging internationalized and localized content in custom client format including translation pairs; and
refining the leveraged content including enhancing content within the data storage medium.

11. The method of claim 10, wherein the deriving step further comprises substeps consisting of obtaining:
a best match Unicode key;
a custom sense;
a dictionary sense;
a replacement character;
a translation;
an in-memory tag structure; and
an element record in a data storage medium.

12. The method of claim 10, wherein the parsing step further comprises substeps consisting of:
checking for previously converted invariant regions;
protecting any invariant regions from tokenization;
breaking up text string into tokens by language appropriate whitespace, and punctuation character segmentation;
applying a Part of Speech algorithm to input text which assigns information to each token;
loading token text into an in-memory tagged data structure and
generating an element record in a data stroage medium.

13. The method of claim 10, wherein the deriving step further comprises substeps consisting of:
pre-pending extra characters to the text string;
appending extra characters to the text string;
assigning extra meaning Unicode replacement characters.

14. The method of claim 11, wherein the substep of obtaining a best match Unicode key further comprises substeps consisting of:
examining each in-memory tag structure token for previous Unicode conversion;
setting each token with a Unicode key format equal to the token value in the in-memory tag structure until all tokens have been so processed;
concatenating tokens found not to be converted to Unicode key format to generate a compound lookup key;
searching a database compound table records for matching compound lookup keys;
concatenating required tokens for each key match;
comparing concatenated tokens to the compound entry with the longest compound first for a complete match; and
setting the token Unicode key attribute in the in-memory tag structure to best match the Unicode key.

15. The method of claim 11, wherein the substep of obtaining a custom sense further comprises substeps consisting of:
examining each non-compound token for part of speech and frequency of use within element and custom sense data base tables;
determining the number of custom senses for each element found;
examining each element for which no custom sense is found for suitability and assigned meaning;
returning a Unicode key from the most probable element record in the data storage medium if meaning is always assigned;
examining the element sense for probability of sense match to Unicode key in the data storage medium being great enough;
generating and assigning an appropriate Unicode key for each token determined to be convertible;
creating an element record in the data storage medium using the generated Unicode key returning the Unicode key for all converted tokens; and
returning all unconverted tokens.

16. The method of claim 11, wherein the substep of obtaining a dictionary sense further comprises substeps consisting of:
determining if the text has a custom, dictionary, or “no” sense;
determining if a Unicode key is available for the sense;
generating a unique Unicode key;
creating an element record in the data storage medium using the generated Unicode key, dictionary sense identification, part of speech, domain information, and glossary flag information; and
returning the Unicode key to the in-memory tag structure for this sense.

17. The method of claim 16, wherein the substep of generating a unique Unicode key further comprises substeps consisting of:
choosing random replacement characters for each character in the input text stream from a pool of character replacements as defined in a data base table;
determining whether the resulting Unicode key is already used in the elements table for the input text;
working from a random character position in the text for each key already used, choosing random different replacement characters from that character's replacement pool until the replacement pool and input characters in the text have been exhausted;
appending a randomly chosen whitespace replacement character to the end of the Unicode key; and
returning the Unicode key to the in-memory tag structure.

18. The method of claim 10, further comprising the step of selecting variable length text string within any editor supporting cut and paste operations.

19. A system for managing terminology and facilitating efficient internationalization and localization of linguistic content contained in a document set stored on a data storage medium and accessible by a microprocessor, the system comprising:
a data input device providing a user-defined, variable length text string session within a client based product and function module to the processor;
an in-memory tag structure module to parse the text string;
a Unicode key module derived from converted in-memory tag structure;
a best match Unicode key module;
a custom/dictionary sense module;
a replacement character module; and
a translation module.

20. The system of claim 19, wherein all modules are server resident.

21. The system of claim 19, wherein the text string originates from any editor supporting cut and paste operations.

22. The system of claim 19, wherein meta-categories are embedded within the text string and hidden as custom fonts.

23. The system of claim 22, further comprising content search and retrieval by meta-category.

24. The system of claim 19, further comprising a client based localization module.

25. The system of claim 19, wherein session parameters further comprise user interface language, document language, organization and product.

26. The system of claim 19, wherein the translation module further comprises mapping original source characters to non-original source characters.

27. The system of claim 26, further comprising sense overrides.

28. The system of claim 19, further comprising at least one internationalization template.

29. The system of claim 19, further comprising at least one internationalization record mechanism.

30. The system of claim 19, further comprising at least one masking module.

31. The system of claim 19, further comprising at least one leverage module.

32. The system of claim 19, further comprising at least one client side navigation module.

33. The system of claim 19, further comprising at least one portal module to provide upload of appropriately authored or proofed text and download of language file analogies.

34. The system of claim 19, further comprising at least one translation workbench module to provide hierarchical data.

35. The system of claim 19, further comprising at least one distributed database with extensive search capabilities provided by a packet network, such as the Internet or a corporate intranet, including those networks made available using browser technology in conjunction with the World Wide Web.

36. The system of claim 35, further comprising a user authentication module.

37. The system of claim 36 further comprising a session parameter module.

38. A computer-program product for use in a system having at least one data communications network, at least one content server connected to the data communications network, a data storage medium, and at least one end user electronic display device connected to the data communications network, wherein the network is a distributed hypermedia environment, the computer program comprising a computer usable medium having computer readable program code physically embedded therein, the computer program code further comprising:
computer readable program code to cause the content server to supply supplemental content to at least one client system which employs any editor supporting cut and paste operations;
computer readable program code to initiate a user-defined, variable length text string within a client based product and function to the server;
computer readable program code to parse the text string into a converted in-memory tag structure;
computer readable program code to derive a Unicode key from the converted in-memory tag structure;
computer readable program code to embed a plurality of data storage medium targets to the converted tag structure;
computer readable program code to leverage internationalized and localized content in custom client format including translation pairs; and
computer readable program code to refine the leveraged content and to enhance the leveraged content within the data storage medium.

39. The computer-program product of claim 38, further comprising computer readable program code to obtain:
a best match Unicode key;
a custom sense;
a dictionary sense;
a replacement character;
a translation; and
returning a fully converted in-memory tag structure.

40. The computer-program product of claim 38, further comprising computer readable program code to:
check for previously converted invariant regions;
protect any invariant regions from tokenization;
break up text string into tokens by language appropriate whitespace, and punctuation character segmentation;
apply a Part of Speech algorithm to input text which assigns information to each token; and load token text into in-memory tagged data structure.

41. The computer program product of claim 38, further comprising computer readable program code to:
prepend extra characters to the text string;
append extra characters to the text string;
assign extra meaning Unicode replacement characters; and
hide metadata using custom fonts.

42. The computer program product of claim 39, further comprising computer readable program code to:
examine each in-memory tag structure token for previous Unicode conversion;
set each token with a Unicode key format equal to the token value in the in-memory tag structure until all tokens have been so processed;
concatenate tokens found not to be converted to Unicode key format to generate a compound lookup key;
search a database compound table records for matching compound lookup keys;
concatenate required tokens for each key match;
compare concatenated tokens to the compound entry with the longest compound first for a complete match; and
set the token Unicode key attribute in the in-memory tag structure to best match the Unicode key.

43. The computer program product of claim 39, further comprising computer readable program code to:
examine each non-compound token for part of speech and frequency of use within element and custom sense database tables;
determine the number of custom senses for each element found;
examine each element for which no custom sense is found for suitability and assigned meaning;
return a Unicode key from the most probable element sense in the data storage medium if meaning is always assigned;
examine the element sense for probability of sense match to Unicode key in the data storage medium being great enough;
generate and assign an appropriate Unicode key for each token determined to be convertible;
return the Unicode key for all converted tokens; and
return all unconverted tokens.

44. The computer program product of claim 39, further comprising computer readable program code to:
determine if the text has a custom, dictionary, or “no” sense;
determine if a Unicode key is available for the sense;
generate a unique Unicode key;
create an element record in the data storage medium using the generated Unicode key, dictionary sense identification, part of speech, domain information, and glossary flag information; and
return the Unicode key for this sense.

45. The computer program product of claim 44, further comprising computer readable program code to:
choose random replacement characters for each character in the input text stream from a pool of character replacements as defined in a data base table;
determine whether the resulting Unicode key is already used in the elements table for the input text;
work from a random character position in the text for each key already used, and choose random different replacement characters from that character's replacement pool until the replacement pool and input characters in the text have been exhausted;
append a randomly chosen whitespace replacement character to the end of the Unicode key; and
return the Unicode key.
